(19) United States
(12) Patent Application Publication
(10) Pub. No.: US 2025/0236691 A1
(43) Pub. Date: Jul. 24, 2025

(54) SURFACE POLYMERIZATION CONTROL

(71) Applicant: RadiSurf, Inc., Cupertino, CA (US)

(72) Inventors: Nicolaj Inunnguaq Jessen, Hinnerup (DK); Jakob Pagh Nikolajsen, Horning (DK); Joydeb Mandal, Lystrup (DK); Elena V. Rogojina, San Jose, CA (US); Mie Blom Lillethorup, Risskov (DK); Byung Sung Kwak, Portland, OR (US); Mikkel Skorkjær Kongsfelt, Odder (DK)

(21) Appl. No.: 19/174,193

(22) Filed: Apr. 9, 2025

Related U.S. Application Data
(63) Continuation of application No. PCT/US2024/012345, filed on Jan. 22, 2024.
(60) Provisional application No. 63/440,145, filed on Jan. 20, 2023.

(30) Foreign Application Priority Data
Jan. 20, 2023 (DK) 2023 70032

(51) Int. Cl. C08F 120/14; B01J 31/22; C08F 2/01; C08F 293/00; C08J 7/16

(52) U.S. Cl. CPC C08F 120/14; B01J 31/2243; C08F 2/01; C08F 293/005; C08J 7/16; C08F 2400/02; C08F 2438/01

(57) ABSTRACT

Reaction compositions for surface polymer formation may comprise: at least one monomer; at least one ligand and at least one catalyst, wherein the at least one ligand and the at least one catalyst form a complex; at least one solvent; and at least one polymerization control agent for controlling at least one of pH and molecular oxygen concentration. Systems and methods are described which utilize these reaction compositions for forming surface polymers.

### CROSS-REFERENCE TO RELATED APPLICATIONS

This application is a continuation of International Patent Application No. PCT/US2024/012345, filed on Jan. 22, 2024, which claims the benefit of U.S. Provisional Application No. 63/440,145 titled “Reaction compositions for surface polymerization, methods for forming surface polymers on a substrate and systems for performing the methods” filed Jan. 20, 2023, and Danish Application No. PA 2023 70032 titled “Reaction compositions for surface polymerization, methods for forming surface polymers on a substrate and systems for performing the methods” filed Jan. 20, 2023, the disclosures of each of which are incorporated by reference in their entireties herein.

### FIELD

Embodiments of the present disclosure relate generally to controlled polymer propagation on surfaces and to reaction compositions for controlled surface polymerization, methods of controlled surface polymerization, and apparatus for forming surface polymers on substrates.

### BACKGROUND

Well-defined polymeric structures on surfaces have become increasingly important in many technologies and applications. “Surface polymers” or “surface bound polymers” describes a polymeric structure having polymer chains that are chemically bonded to a surface at one end through covalently bound polymerization initiators. Two methods, known by persons skilled in the art, can be used to achieve such polymeric structure, namely the “grafting to”-approach and the “grafting from”-approach (See FIGS. 1 a) and b)). In the “grafting to”, polymers are pre-prepared in solution and then deposited onto the surface in question, since the pre-prepared polymers are designed in such a way that one of the chain-ends has some affinity for the surface of interest. Upon contact with the surface of interest, the polymers will self-assemble on said surface forming surface bound polymers. In the “grafting from” approach, small molecules capable of acting as polymerization initiators are covalently bound to the surface of interest in a pre-polymerization step. Subsequently polymerization is initiated via the polymerization initiators. Accordingly, surface polymers are formed from the surface.

While the “grafting to” approach allows for simple preparation procedures, in that one can prepare the polymers using conventional polymerization methods and store those polymers before initiating the self-assembly procedure, the “grafting to”-approach lacks the ability to form high density surface bound polymeric structures. The main problem being the self-assembly process being halted by the steric repulsion between the pre-prepared polymers as they self-assemble on the surface (See FIG. 1 a). The “grafting from”-approach allows for the formation of highly dense surface bound polymer structures, as the small molecules can form a much more densely packed layer on the surface (compared to large polymer molecules, see FIG. 1 b). As such, the surface bound polymer structure formed by a grafting from approach results in a much higher density. Additionally, as the “grafting from” approach allows for highly dense surface bound polymer structures, a brush like structure can be achieved, thus, the name “polymer brush”. In these structures, the polymers are stretched and forced to stand up-right as a result of the steric repulsion between the neighboring polymers creating a unique structure known by people skilled in the art as a “polymer brush” structure. On surfaces, the structures are tethered/attached, usually covalently, at one end to a surface, typically to a solid or semisolid surface, thereby differing from polymers formed in solution and subsequently deposited onto a surface.

As mentioned above, surface polymers are prepared by one of the following two main strategies: “grafting to” or “grafting from”. In the “grafting to” approach, polymer chains are deposited onto the surface in question. The “grafting to” approach suffers from several drawbacks and limitations making it difficult to produce thick and dense surface polymers. In the “grafting from” approach, the surface polymer growth (surface polymer chain propagation, extension of the chain by monomer units) is initiated from initiator-functionalized surfaces, in particular using a controlled/“living” polymerization technique, such as anionic polymerization, cationic polymerization, ring-opening polymerization, and radical polymerization.

Surface polymers within the present context are, thus, polymeric structures having polymer chains that are chemically bonded to a surface at one end. Such surface polymers can be tailored to provide specific chemical and/or physical properties and can produce precisely tailored chemical structures on a molecular scale. They may be used, for example, for storing certain chemical species, controlling transport properties, improving surface stability and properties, creating an interface in which dissimilar materials can bind or interact, and other functions. Surface polymers can subsequently join otherwise incompatible materials such as metals and plastics and improve adhesion between otherwise incompatible materials (see, e.g., WO 2014 075695 A1).

Different polymerization techniques have facilitated the specific design and synthesis of surface polymers with strict molecular control and desired properties. In particular, the surface polymers can be viewed as nanoscale “building blocks” with a wide range of uses, varying from redox activity to biocompatibility and surface alteration, and due to the flexibility of the surface polymers, highly tailored thin films of surface polymers can be created with respect to chemical composition, thickness, grafting density and architecture.

Several methods for forming surface polymers are known, among them SI-ATRP (surface-initiated atom transfer radical polymerization), SI-RAFT (surface-initiated reversible-addition fragmentation chain transfer), SI-NMP (surface-initiated nitroxide-mediated polymerization), SI-PIMP (surface-initiated photoiniferter-mediated polymerization), and SI-A(R)GET (surface-initiated activators (regenerated) by electron transfer) ATRP. A review is given in Chem. Rev. 2009, 109, 5437-5527. Other approaches include SET-LRP (single-electron transfer living radical polymerization) and SARA ATRP (supplemental activator and reducing agent atom transfer radical polymerization).

When forming surface polymers, polymerization initiators are firstly formed on the surface onto which the surface polymers are to be formed. Secondly, the surface is brought into contact with suitable monomers, catalysts, ligands and optionally a solvent, or suitable monomers, catalysts, ligands, a reducing agent and optionally a solvent, whereby the surface polymer can form using certain reaction conditions. The polymerization initiators and the monomers are chosen so as to suit the purposes and properties of the resulting surface polymers. Surface polymers may also be formed as layers of surface polymers by repeating the polymeric architecture, e.g., using another starting monomer (block-copolymers).

Among these known procedures for formation of surface polymers, (ARGET) ATRP and SET-LRP are widely used. For the polymerizing chains to propagate, a monomer, a catalyst, a ligand and a solvent are needed. In (ARGET) ATRP and SET-LRP polymerizations, some reactions activate the catalyst, thereby, promoting polymerization, and at the same time, other reactions deactivate the catalyst to impede polymerization. SARA-ATRP and SET-LRP are described, e.g., in https://www.cmu.edu/maty/atrp-how/procedures-for-initiation-of-ATRP/SARA-ATRP-or-SET-LRP.html.

Both the SET-LRP and (ARGET) ATRP methods rely on the formation of a complex between the ligand and a halide formed with a transition metal (usually CuCl₂ or CuBr₂ in the case of ARGET ATRP, and Cu(0) in the case of SET-LRP, but other transition metals and halogens may be used).

The ARGET ATRP involves a halogen transfer between a dormant halogen capped species, P₁—X and Cu(I)X catalyst, resulting in the formation of a propagating radical (Pₙ radical) and Cu(II)X₂. The propagating radical undergoes polymerization with monomers, forming the growing polymer chain. Controlling the ratio between Cu(I)X and Cu(II)X₂ allows control of the polymerisation itself. This is well-known for these types of polymerizations.

In ARGET ATRP, a reducing agent (like ascorbic acid or sodium ascorbate) is added to the polymerization to continuously regenerate active Cu(I)X species from inactive Cu(II)X₂ (the latter species will inevitably form from the termination event in an ATRP process). In the classic ARGET ATRP process, it is still important to maintain control of the ATRP equilibrium, which is also impacted by the concentration of reducing agent. The reducing agent is used in very small amounts to maintain control over the polymerization. The ARGET ATRP procedure is oxygen-sensitive and only very small amounts of oxygen are tolerable (the reaction container is sealed upon mixing of reagents). The trapped oxygen will be removed by addition of reducing agent and is referred to as an “incubation” process. It is necessary to seal the reaction container during polymerization as exposure to atmospheric oxygen will rapidly terminate (quench) the polymerization reaction due to oxidation of the active Cu(I)X catalyst to the inactive Cu(II)X₂ form. The polymerization reaction is further driven by the presence of catalytically active Cu, and in particular the equilibrium between activating catalysts, such as Cu(I)X/L species (where L is a ligand and X a halogen), and deactivating catalysts, such as Cu(II)X₂/L species, is used to control the kinetics of the polymerization. This equilibrium is difficult to control, rendering many methods to form surface polymers unpredictable and short-lived. Furthermore, a major disadvantage with the prior art techniques is the system's susceptibility to oxygen as mentioned above. Molecular oxygen (O₂) is capable of oxidizing species which may be employed as activating catalysts in surface polymerizations, such as Cu(I)X/L species, to produce species which may be employed as deactivating catalysts in surface polymerizations, such as Cu(II)X₂/L species. Thus, in the presence of O₂ the catalyst species may be present overwhelmingly in the form which is responsible for deactivating the surface polymerization, and the surface polymer formation will be slow. A solution to this problem has been to let the reaction take place under an atmosphere which is devoid of O₂; however, in such instances the polymerization solution remains short-lived as the system is exposed to oxygen during handling of the material onto which the surface polymers are formed. In the SET-LRP, Cu(0) in solid form (powder, nanoparticles) is used together with a ligand. For the SET-LRP procedure, Cu catalyst is extracted from solid Cu present in the reaction composition, and hence the catalyst concentration will increase during the cause of the polymerization, making control of kinetics challenging. Thus, the polymerization solution can be used only once, rendering the prior art methods unsuitable or impractical for high-volume-manufacturing (HVM) of surface polymers. These drawbacks make uniform propagation of surface polymers with a highly stable kinetics very difficult.

From WO 2019 196999 A1, which is incorporated by reference in its entirety, as if fully set forth herein, an alternative oxygen-tolerant method for forming surface polymers is disclosed. The catalyst/ligand complex described in WO 2019 196999 A1 is halogen free in so far as the catalyst/ligand complex formed is not complexed with a halogen anion. An advantage of this method is that the complex formed between the transition metal and the ligand is inactive (i.e., not available for initiating polymerization of the monomer) and stable (oxygen-insensitive), but the system can be activated “on demand”, thus, initiating polymerization and propagation of the surface polymers.

To fully exploit the potential of the surface-polymer technology, there is a need for an efficient way of forming surface polymers, both on a small, R&D, scale, and on a large, high-volume manufacturing, scale.

### SUMMARY

In accordance with an aspect of the disclosure there is provided a reaction composition for surface polymer formation comprising: at least one monomer; at least one ligand and at least one catalyst, wherein the at least one ligand and the at least one catalyst form a complex; at least one catalyst activator; at least one solvent; and at least one polymerization control agent. Furthermore, the at least one polymerization control agent may be at least one pH control agent for controlling the pH of the reaction composition during surface polymer formation. Furthermore, the at least one polymerization control agent may comprise at least one pH control agent for controlling pH in the reaction composition during surface polymer formation and at least one oxygen control agent for controlling the molecular oxygen concentration in the reaction composition during surface polymer formation. Furthermore, the at least one pH control agent may maintain the pH of the reaction composition above a pKₐH value of the formed between at least one catalyst and at least one ligand. Furthermore, the at least one pH control agent may maintain the pH of the reaction composition above the pKₐH₁ value of the formed between the at least one catalyst and the at least one ligand. Furthermore, the at least one pH control agent may maintain the pH of the reaction composition above the pKₐH₂ value of the complex formed between the at least one catalyst and the at least one ligand. Furthermore, the at least one pH control agent may maintain the pH of the reaction composition between the pKₐH₁ and pKₐH₂ of the complex formed between the at least one catalyst and the at least one ligand. The at least one pH control agent may maintain the pH of the reaction composition above 6, and in some embodiments from 8 to 12. The at least one pH control agent may be a buffer. The at least one pH control agent may be an acid or a base. The at least one polymerization control agent may be at least one oxygen control agent for controlling the molecular oxygen concentration in the reaction composition. The at least one oxygen control agent may maintain the molecular oxygen concentration in the reaction composition, corresponding to a partial pressure below or at 25 hPa. The at least one oxygen control agent may comprise an oxygen scavenger. The reaction composition for surface polymer formation may comprise a pH control agent, or an oxygen control agent, or a pH control agent and an oxygen control agent.

In particular, the reaction composition may comprise a solvent, a monomer, a catalyst; a ligand, where the catalyst and ligand form a complex; and a polymerization control agent being a pH control agent; or a pH control agent and an oxygen control agent.

In accordance an aspect of the disclosure there is provided a method for forming surface polymers comprising: bringing at least a portion of a polymerization initiator-modified substrate into contact with a reaction composition comprising at least one monomer; at least one ligand; at least one catalyst, wherein the at least one ligand and at least one catalyst form a complex; at least one catalyst activator; and at least one solvent; controlling the surface polymerization by means of pH and/or molecular oxygen concentration of the reaction composition; and optionally adding at least one polymerization control agent to adjust the pH of and/or the molecular oxygen concentration of the reaction composition. Furthermore, the at least one polymerization control agent may be added at least once during or prior to the surface polymer formation. The at least one polymerization control agent may be (i) at least one control agent, (ii) at least one oxygen control agent, or (iii) at least one pH control agent and at least one oxygen control agent. The at least one polymerization control agent may function as pH control agent and oxygen control agent.

In accordance with an aspect of the disclosure, a method for forming surface polymers is provided, the method comprising: providing a reaction composition comprising at least one monomer; a least one ligand; at least one catalyst, wherein the at least one ligand and the at least one catalyst form a complex; at least one catalyst activator; and at least one solvent, wherein the reaction composition is held in a reaction composition container; bringing at least a portion of a first polymerization initiator-modified substrate into contact with the reaction composition in the reaction composition container thereby forming surface polymers on said first substrate; withdrawing said first substrate from the reaction composition in the reaction composition container; subsequent to the withdrawing said first substrate, bringing at least a portion of a second polymerization initiator-modified substrate into contact with the reaction composition in the reaction composition container thereby forming surface polymers on said second substrate; withdrawing said second substrate from the reaction composition in the reaction composition container; wherein the pH and/or the molecular oxygen concentration in the reaction composition may be controlled by means of optionally at least one polymerization control agent. The reaction composition may be modified during the surface polymer formation by addition of further components of the reaction composition, and/or by removal of bulk polymer byproducts. The pH of the reaction composition and/or molecular oxygen concentration in the reaction composition may be controlled by measuring pH and/or molecular oxygen concentration during the surface polymer formation in combination with supplying at least one polymerization control agent. A plurality of substrates may be subjected to surface polymer formation in the reaction composition container in a consecutive manner. The pH of the reaction composition may be adjusted to control the kinetics of the surface polymer formation.

In accordance with an aspect of the disclosure a system for forming surface polymers on a substrate is provided. The system may comprise: a reaction composition container containing a reaction composition, wherein the reaction composition may comprise at least one monomer, at least one ligand, at least one catalyst, wherein the at least one ligand and the at least one catalyst form a complex, at least one catalyst activator, and at least one solvent; and a substrate displacement device for bringing at least a portion of a polymerization initiator-modified substrate into contact with the reaction composition in the reaction composition container for a controlled time; and wherein the controlled time is sufficient to enable surface polymers to be formed on a portion of the polymerization initiator-modified substrate. In accordance with at least some embodiments, the substrate displacement device may comprise any one of: a conveyor system; a programmable mechanical arm; or a roll-to-roll mechanism. In some embodiments the system may further comprise: one or more sensors, each sensor configured to measure a different value of a characteristic of the reaction composition; one or more dispensers configured to dispense one or more polymerization control agents and/or one or more components of the reaction composition into the reaction composition; and a control unit operatively connected to the one or more sensors; wherein the control unit may be configured to output a control signal to the one or more dispensers for dispensing the polymerization control agent and/or one or more components of the reaction composition into the reaction composition. In accordance with some embodiments the control unit is configured to output the control signal periodically to the dispenser, causing the dispenser to periodically dispense the polymerization control agent and/or the component of the reaction composition into the reaction composition. In accordance with some embodiments the control unit may be configured to output the control signal in dependence on receipt of a sensor signal indicative of a change in a value of a characteristic of the reaction composition. In some embodiments the control unit may be configured to output the control signal in dependence on receipt of a sensor signal indicative of the measured value of the characteristic of the reaction composition not complying with a predetermined threshold value of the characteristic of the reaction composition. The predetermined threshold value may be a pH value and/or molecular oxygen concentration. The output control signal may cause pH control agent and/or oxygen control agent to be dispensed into the reaction composition. In accordance with some embodiments, the component of the reaction composition may comprise any one or more of: at least one monomer, at least one ligand, at least one catalyst, at least one catalyst activator, and at least one solvent. In some embodiments the system may further comprise a polymerization initiator container containing a polymerization initiator agent, wherein the substrate displacement device is configured to bring the portion of the substrate for attachment of polymerization initiators into contact with the polymerization initiator agent to form polymerization initiators on the substrate surface, prior to bringing the portion of the polymerization initiator-modified substrate into contact with the reaction composition. The system may comprise a cleaning container, the cleaning container containing a cleaning agent, and wherein: the substrate displacement device may be configured to bring the portion of the polymerization initiator-modified substrate into contact with the cleaning agent prior to, or subsequent to, bringing the portion of the polymerization initiator-modified substrate into contact with the reaction composition; or, the substrate displacement device may be configured to bring the portion of substrate into contact with the cleaning agent prior to or subsequent to, bringing the portion of the substrate into contact with the polymerization initiator. Some embodiments may comprise an annealing container containing an annealing agent, wherein the substrate displacement device may be configured to bring the portion of the substrate into contact with the annealing agent prior to, or subsequent to, bringing the portion of the substrate into contact with the polymerization initiator or prior to, or subsequent to, bringing the portion of the substrate into contact with the reaction composition.

In accordance with a further aspect of the disclosure, a system for forming surface polymers on a substrate is provided. The system may comprise: a reaction composition container; a cleaning container; a polymerization initiator container; and a substrate displacement device. The system may further comprise an annealing container and/or a drying container. In accordance with some embodiments, the cleaning container's function may comprise one or more of etching; thermal cleaning; and removal of surface contaminants, by-products, and residual process chemicals. The system may be for forming surface polymers with stable kinetics according to the methods disclosed herein.

At least some embodiments of the present disclosure provide a solution to the aforementioned prior art problems by providing reaction compositions and methods with a controlled formation of surface polymers, in particular polymer brushes. It has surprisingly been found that controlling certain reaction conditions during the surface polymer formation stabilizes the activity of the reaction composition and in turn ensures stable and constant kinetics of the surface polymer formation, reduces undesired side reactions, and provide a unique control over formed surface polymers and surface polymer thickness. Furthermore, the disclosure herein makes possible re-using the reaction composition for multiple surface polymer formation events on substrates in a consecutive manner.

Thus, the present disclosure enables high-volume manufacturing (HVM) as well as smaller-scale manufacturing of substrates with surface polymers.

### DESCRIPTION OF THE DRAWINGS

Certain embodiments of the present disclosure are illustrated in the accompanying drawings. The drawings are, however, in no way intended to limit the present disclosure. In the drawings:

FIG. 1 illustrates the general strategies of a) “grafting to” approach; and b) “grafting from” approaches, where a) illustrates steric hindrance of pre-formed polymers when attaching to the surface, and b) illustrates the upright nature of polymers formed from monomeric units ensuring higher density of formed polymers than a) (occupation of polymers from more initiator sites than possible with the “grafting to” approach);

FIG. 2 illustrates the general process for ATRP-based polymerization reactions;

FIG. 3 illustrates theoretical, stable surface polymer formation kinetics in case of a linear dependency between surface polymer length and polymerization time;

FIG. 4 illustrates theoretical, stable surface polymer formation kinetics in case of a non-linear dependency between surface polymer length and polymerization time;

FIG. 5 illustrates the polymerization of FIG. 3 with a variation of +1-15% variation in formed surface polymer thicknesses;

FIG. 6 illustrates the polymerization of FIG. 4 with a variation of +1-15% variation in formed surface polymer thicknesses;

FIG. 7 is a schematic illustration of a system for forming surface polymers on at least a portion of a substrate, in accordance with an embodiment;

FIG. 8 is a schematic illustration of an exemplary substrate displacement device, in the substrate displacement device comprises a roll-to-roll processing device, in accordance with an embodiment;

FIG. 9 is a detailed schematic illustration of the reaction composition container comprising the reaction composition shown in FIG. 7;

FIG. 10 is a process flow chart illustrating an iterative process for controlling the pH of the reaction composition, in accordance with an embodiment;

FIG. 11 is a process flow chart illustrating an iterative process for controlling the oxygen content of the reaction composition, in accordance with an embodiment;

FIG. 12 is a process flow chart illustrating the different processing steps comprised in a system for forming surface polymers, in accordance with a further embodiment;

FIG. 13 shows the molecular oxygen concentration after addition of sodium ascorbate, cf. Example 5;

FIG. 14 shows polymer brush thicknesses, pH and partial pressure of O₂ as a function of time, cf. Example 5;

FIG. 15 shows the dry film thicknesses on substrates obtained by the procedure described in Example 5;

FIG. 16 shows obtained polymer brush thicknesses and partial pressures of O₂ as a function of time, cf. Example 6;

FIG. 17 shows surface polymer thicknesses during a reaction composition lifetime of 120 minutes, cf. Example 6;

FIG. 18 shows dry film thicknesses as a function of time, cf. Example 7;

FIG. 19 shows pH as a function of time, cf. Example 7;

FIG. 20 shows UV/Vis data for CuCl₂, Me₆TREN and CuCl₂ plus Me₆TREN, respectively, cf. Example 8;

FIG. 21 shows the titration curve in accordance with the experiment in Example 8;

FIG. 22 shows dry film thicknesses of formed surface polymers on stainless steel as a function of time after activation of the catalyst/ligand complex, cf. Example 9;

FIG. 23 shows dry film thicknesses of formed surface polymers on silicon wafers as a function of time after activation of the catalyst/ligand complex, cf. Example 9;

FIG. 24 shows measured pH over time, cf. the results obtained in Example 9;

FIG. 25 shows the dry film thickness of surface polymers as a function of time after activation of the catalyst/ligand complex of the reaction composition, cf. Example 10;

FIG. 26 shows continuous measurements of pH and partial O₂ pressures, cf. Example 10;

FIG. 27 shows measured surface polymer thickness, pH and O₂ partial pressures as a function of time, cf. Example 11.

FIG. 28 shows bulk polymer formation depending on pH of the reaction composition, cf. Example 12 (FIG. 28) showing composition A, showing composition B, showing composition C, showing composition D (which was also representative of compositions E and F).

FIG. 29 shows obtained surface polymer thicknesses as a function of polymerization time, cf. Example 12.

FIG. 30 shows pH as a function of time, cf. Example 12.

FIG. 31 shows obtained surface polymer thicknesses and pH measurement as a function of time, cf. Example 13.

FIG. 32 shows a comparison between degrafted PMMA-b-PST (block copolymer) with reference spectra for PMMA and PST, cf. Example 14.

FIG. 33 shows ellipsometric data, O₂ and pH measurements, cf. Example 15.

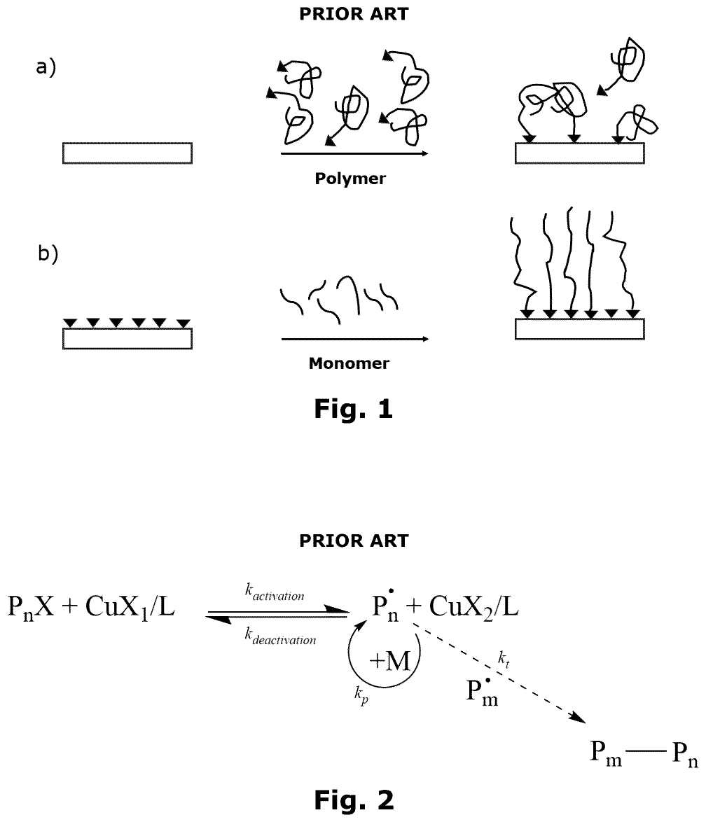

### DETAILED DESCRIPTION

In a first aspect, the present disclosure provides a reaction composition for surface polymer formation comprising at least one monomer; at least one ligand; at least one catalyst, wherein the at least one ligand and the at least one catalyst form a complex; at least one catalyst activator; at least one solvent; and at least one polymerization control agent. The inventors have discovered that with this reaction composition, the kinetics of the surface polymer formation is both controllable and remains stable for surface polymer formation during an extended timeframe. In particular, the polymerization control agent may be at least one pH control agent for controlling the pH of the reaction composition during surface polymer formation. In particular, the polymerization control agent may be at least one oxygen control agent for controlling the molecular oxygen concentration (O₂ dissolved) in the reaction composition. In some applications, the reaction composition may include both at least one pH control agent and at least one oxygen control agent. The thickness of formed surface polymers are indicators for successful formation of surface polymers both on a small scale and in particular on a large scale (high-volume).

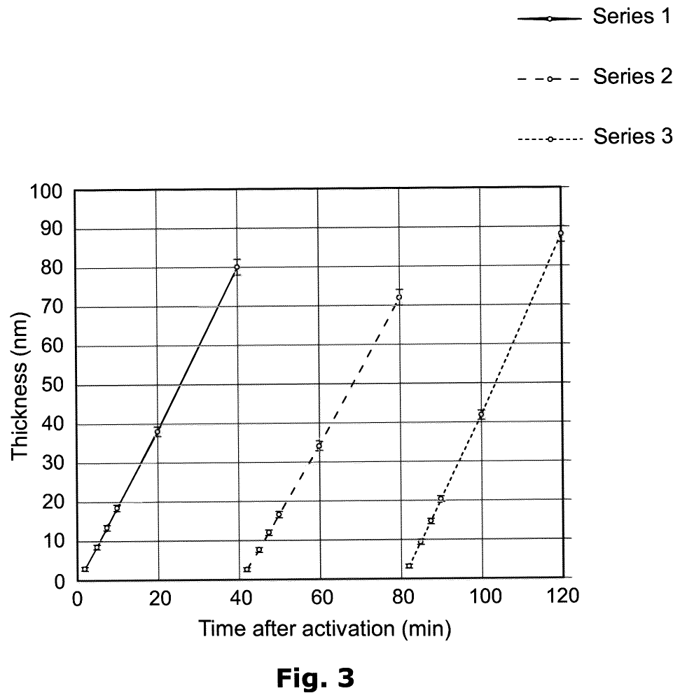

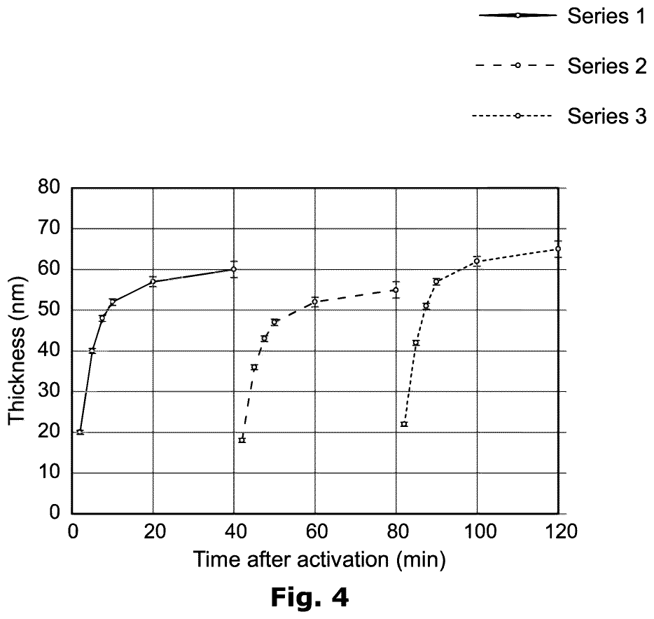

By the expression “kinetics” in the context of surface polymer formation is meant that within a given timeframe, surface polymerization (propagation of polymer chains) occurs as a function of time to an extent where a certain surface polymer thickness is obtained. In some cases, the relationship between surface polymer thickness and polymerization time is linear as exemplified by FIG. 3. In other cases, the relationship between surface polymer thickness and polymerization time is nonlinear as exemplified by FIG. 4.

By the wording “stable kinetics” is meant that the thickness of surface polymers formed throughout multiple surface polymer formation events of the same duration (on multiple substrates in a sequential or consecutive manner) is within +/−20%, preferably +1-15%, of the average thickness obtained throughout the lifetime of the reaction composition and/or the number of substrates subjected to a surface polymer formation. The lifetime is defined as the timeframe wherein the thickness of formed surface polymers does not deviate from this range.

In general, three types of surface polymer “coatings” are known, namely:

1) Preformed polymers which are deposited onto a substrate either as a polymer melt by e.g. a molding process, by doctor blading or spin coating a dilute solution of the polymer in a suitable solvent. No covalent bonds are formed between the polymer and the surface in this methodology, barring the presence of specific reactive groups on both the substrate surface and the polymer itself. In the case that such reactive groups are present on both polymer and substrate surface, the polymer is “grafted to”, which is described further below.
2) “Grafting to” is a method of attaching a polymer chain to a surface. The polymer chains are covalently attached to the surface at one chain-end. The method is known to the person skilled in the art, to comprise pre-forming polymers in solution, said polymers having a reactive chain-end group. In solution, these polymers are not yet surface attached. The reactive end group can react with a suitable reactive group on the surface in question. Typically, the reactive group is deposited or in another way pre-formed on the surface. The pre-formed polymer is brought into solution, where the conformation of the individual polymer chains is subject to solvent interactions and energetics. Generally, the chains will adopt some version of the coiled coil to maximize entropy. This conformation is retained when the reactive chain-ends react with the reactive groups on the surface. The area occupied by grafting this polymer coil to the surface is generally much larger than the area occupied by the reactive surface group, and, thus, neighboring reactive surface groups are blocked for reaction by the polymer coil. A much higher polymer grafting density could theoretically be obtained if a chain was grafted to the surface in a stretched, linear conformation. Such a conformation is, however, not achievable for polymers in solution given the entropically favored coiled coil conformation which the chains will adopt in solution. The straight and linear polymer conformation is highly unfavored by entropy and is thus not generally observed for polymers in solution. However, a surface polymer coating consisting of polymer chains with a more linear conformation, attached to the surface with a much higher density can be obtained using the “Grafting From” methodology described below.
3) In the “Grafting From” method, the surface which is to be modified with a surface polymer is firstly modified with molecules containing a polymerization initiator. Polymerization initiators are covalently attached. Given the small size of such polymerization initiator molecules relative to a coiled coil polymer as described above, the density of such initiators on the surface can be much higher than that which is obtained when grafting polymer coiled coils directly to the surface in the “Grafting To”-approach described above. Following polymerization initiator modification/deposition, polymer chains are grown from these surface anchored initiators by extension of the polymer chain by monomeric units. The conformation of these polymers is governed by entropy as described above, but also by the fact that the high density of initiators on the surface means that each formed polymer chain will interact with its neighboring chains, giving rise to steric repulsion. As such, the conformation of these chains becomes a balancing act between entropy, which favors the coiled coil, and the steric constraints imposed by the high density of the polymer chains, forcing the chains to stretch away from the surface to occupy as little space as possible. The result is that polymer chains stretch away from the surface to reduce steric interactions, despite this conformation being of a lower entropy than e.g. the coiled coil. Polymer chains anchored covalently to the surface at one end, and confined to the stretched conformation are considered a special type of surface polymers, namely “polymer brushes”. Polymer brushes can only be formed by the “grafting from” approach which circumvents the low grafting density obtained by the “grafting to”-approach described above.

It is to be understood that by the term “thickness of a surface polymer” is meant a surface polymer formed by propagating polymer chains (extension of a polymer chain by a monomer unit) from polymerization-initiators on the surface of the substrate during a certain time where the substrate is in contact with the reaction composition. The thickness is often measured as the dry film thickness by ellipsometry.

Accordingly, the substantially uniform formation of surface polymers in consecutive surface polymer formation events is possible in cases where similar timeframes and conditions for surface polymer formation are performed, that is each substrate stays in the reaction composition for a predefined time. Thus, a targeted surface polymer thickness may be obtained within the applied predefined polymerization time, that is a thickness within +/−20%, preferably +/−15%, of the average thickness obtained during the multiple surface polymer formation events as determined by dry film thickness of collapsed surface polymers.

In the abovementioned scenarios, control of the polymerization kinetics is a desirable aspect. In FIG. 2, a general pathway for the known ATRP processes is shown. Herein, the equilibrium between dormant alkyl halides and active, propagating alkyl radicals, as dictated by the rate constants, k_{activation} and k_{deactivation}, is central to the kinetics with which surface polymer formation occurs.

In general, surface polymer formation or propagation (extension of a polymer chain by a monomer unit) is a repeatable process which depends on an active, propagating alkyl radical and a monomer unit, resulting in a certain thickness of the surface polymer. Eventually, the resulting surface polymer thickness is a direct result of the number of times with which propagation successfully has occurred. Certain processes may irreversibly deactivate active, propagating alkyl radicals e.g., through recombination and disproportionation between two alkyl radicals, resulting in a polymerization rate which decreases over time. These processes may be grouped as termination events, i.e., the propagation at polymer chains is terminated. It is noted that such termination affects the surface polymer growth on the specific substrates upon which the termination events occur, but not the polymer-forming ability of the reaction composition as a whole. Replacement of a substrate with high degree of termination in the reaction composition with a non-terminated, initiator-modified substrate may result in surface polymer formation on the latter substrate. The delicate balances between active, propagating alkyl radicals, activating and deactivating catalyst species and termination events is generally very easily disturbed by external factors like changing molecular oxygen concentrations, by-products formed in the reaction composition, changing concentrations etc. which will change the kinetics of the reactions over time, and applies particularly to the known polymerization processes as (ARGET) ATRP and SET-LRP. Hence, the ability to obtain controlled kinetics by controlling certain parameters as demonstrated herein is very surprising given the complicated nature of the polymerization reactions and polymer chain propagation.

Compared to the rate for propagation (with rate constant kp), the rate for termination (with rate constant kₜ) displays the highest dependency on the concentration of active, propagating alkyl radicals. At low concentration, termination is disfavored to a higher degree than propagation. Under such conditions, the relationship between surface polymer thickness and polymerization time may become (close to) linear. In the known procedures, measures to lower the concentration of active, propagating alkyl radicals include lowering the catalyst concentration, e.g., using a ligand which is less activating in ATRP processes, or increasing the concentration of deactivator through addition of a halide source. Linear relationships between surface polymer thickness and polymerization time may allow for high degrees of predictability and control of surface polymer thicknesses by adjusting the polymerization time, at the cost of a lower initial polymerization rate. Contrarily, termination at propagating polymer chain ends may in the known procedures be favored by increasing the concentration of propagating alkyl radicals. Measures to increase the concentration of active, propagating alkyl radicals include increasing the catalyst concentration or using a ligand, which is more activating in ATRP processes. Non-linear relationships between surface polymer thickness and polymerization time may allow for very high initial polymerization rates, at the cost of irreversible deactivation of the polymerization due to termination of propagating polymer chain ends over time.

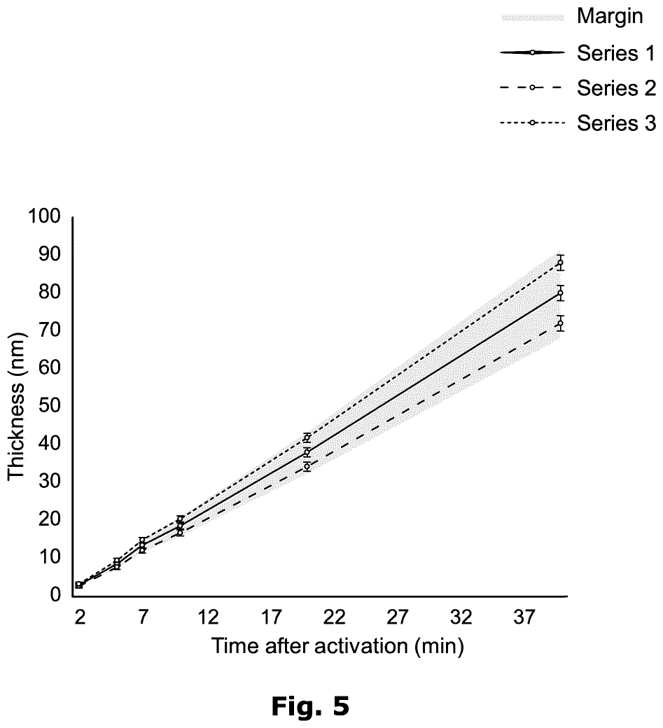

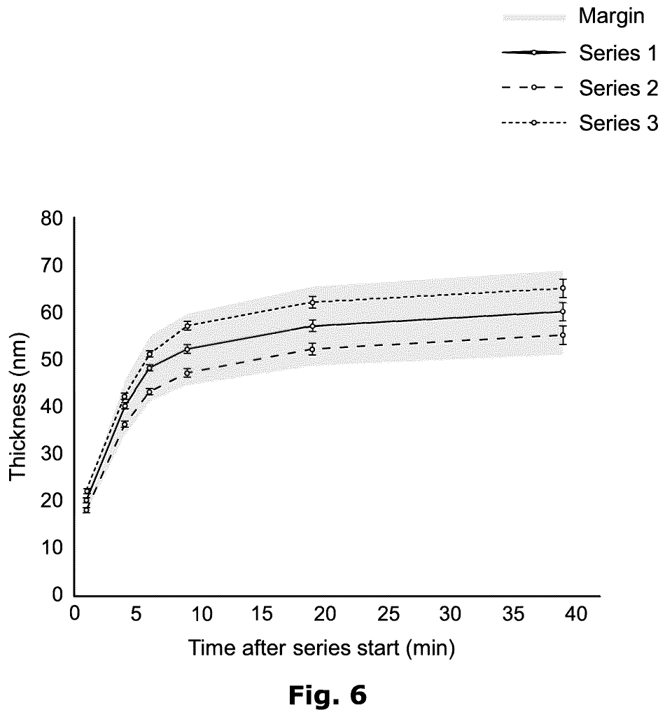

Controlling the rates for both propagation and termination may allow for high degrees of predictability and control of surface polymer thicknesses by adjusting the polymerization time, or by devising a polymerization which terminates once the desired surface polymer thickness has been obtained and can indeed be achieved with the method disclosed herein. Thus, in one embodiment, the surface polymers obtained during the extended timeframe of the reaction composition are achieved in a polymerization displaying linear relationships between surface polymer thickness (y axis) and polymerization time (x axis—polymerization time after activation of catalyst/ligand complex) (exemplified in FIG. 3). In another embodiment, the surface polymers obtained during the extended timeframe of the reaction composition are achieved in a polymerization displaying non-linear relationships between surface polymer thickness (y axis) and polymerization time after activation of catalyst/ligand complex (x axis) (due to termination events; exemplified in FIG. 4). In both embodiments, the kinetics of the reaction composition is stable during the extended timeframe of the reaction composition, allowing for high degrees of predictability and control of surface polymer thicknesses (for illustrations depicting +/−15% deviation from an average thickness of surface polymers on a series of substrates, obtained after a given polymerization time, see FIG. 5 for linear kinetics; FIG. 6 for non-linear kinetics).

In one embodiment, the at least one polymerization control agent is at least one pH control agent for controlling the pH of the reaction composition during surface polymer formation. In one embodiment, the pH control agent may maintain the pH of the reaction composition above a pKₐH value of the complex formed between the catalyst and the ligand. In one embodiment, the at least one pH control agent may maintain the pH of the reaction above the pKₐH₁ of the complex formed between the catalyst and the ligand. In one embodiment, the pH control agent may maintain the pH of the reaction composition above the pKₐH₂ of the complex formed between the catalyst and the ligand. In one embodiment, the pH control agent may maintain the pH of the reaction composition between the pKₐH₁ and pKₐH₂ of the complex formed between the catalyst and the complex. The complex formed between the catalyst and the ligand may also be referred to as catalyst/ligand complex herein.

Within the present context, pH and acid dissociation constants (pKₐ values) apply to catalyst/ligand complexes, acids, bases, and solvents and mixtures thereof, where pH and pKₐ can meaningfully be determined. Since the catalyst/ligand complexes used herein are basic, the term pKₐH is used, which refers to the pKₐ of the conjugate acid. The higher the pKₐH value, the stronger the base. For species which may be protonated more than once pKₐH₁ refers to the pKₐ of the conjugate acid obtained after the “first” protonation, and pKₐH₂ refers to the pKₐ of the conjugate acid obtained after the “second” protonation; pKₐH₁ is in this case always higher than pKₐH₂, i.e., pKₐH₁>pKₐH₂. Specific pKₐ and pKₐH values may be calculated using known titration methods, or, where available, be looked up in various publications and handbooks.

In one embodiment, the polymerization control agent may be at least one oxygen control agent. In another embodiment, the polymerization control agent may be at least one pH control agent and at least one oxygen control agent.

The pH control agent may suitably be any substance capable of adjusting the pH of the reaction composition. The pH control agent should be soluble in water as the reaction composition comprises components which are miscible or soluble in water. The term “water” is intended to mean all types and qualities of water, e.g., tap water, deionized water, and ultrapure water.

In one embodiment, the at least one pH control agent may be a buffer. The term “buffer” is defined herein as an agent which, when added to the reaction composition, can within a certain pH range withstand changes in pH when an acidic or alkaline substance is added to the composition or is formed in the composition. Buffer systems include combinations of a weak acid and its conjugate base, or a weak base and its conjugate acid. Non-limiting examples of buffers are carbonate buffer, glycine buffer, citrate buffer, phosphate buffer, acetate buffer, ammonium buffer (ammonium chloride/ammonia), formate buffer, sodium ascorbate/ascorbic acid buffer, and zwitterionic buffers such as Good's buffers. In some embodiments, such buffering agents may be employed as aqueous solutions or non-aqueous solutions. In other embodiments, such buffering agents may be added as pure substances. Different buffers have different buffering ranges, and in an embodiment the buffer is chosen such that the pH of the reaction composition is above a pKₐH value of the catalyst/ligand complex. By way of example, a sodium carbonate/sodium bicarbonate buffer system may be used to maintain a pH value in the interval 9.2-10.8, or a glycine buffer system may be used to maintain pH in the interval 8.6-10.6.

In an embodiment, the at least one pH control agent may be selected from carbonate buffer, glycine buffer, and phosphate buffer.

In another embodiment, the at least one pH control agent may be a base or an acid which may be inorganic or organic. Non-limiting examples of bases are potassium hydroxide (KOH), lithium hydroxide (LiOH), tripotassium phosphate (K₃PO₄), sodium carbonate (Na₂CO₃), or sodium ethoxide (CH₃CH₂ONa). Non-limiting examples of acids are methanesulfonic acid (MSA), hydrochloric acid (HCl), sulfuric acid (H₂SO₄), phosphoric acid (H₃PO₄), 2,2,2-trifluoroacetic acid (TFA), p-toluenesulfonic acid (pTSA), and nitric acid (HNO₃).

It has been shown herein that by controlling the pH of the polymerization composition within a certain pH range above a pKₐH value of the catalyst/ligand complex, the stability and kinetics of the desired surface polymer formation may be further controlled within an extended timeframe, making possible formation of surface polymers on a plurality of substrates in a consecutive manner. The pKₐH value(s) of a catalyst/ligand complex is(are) determined by the nature of the catalyst and the ligand, respectively, as this species may assume its most active form within a given pH range. Importantly, the pKₐH value(s) of the catalyst/ligand complex may differ from the individual pKₐH value(s) of the catalyst and the ligand alone (uncomplexed). In some embodiments, the lower boundary in the pH value range is defined as the pH at which the catalyst and the ligand may no longer produce a complex, but exist in the reaction composition as separate species, for example due to excessive protonation of the ligand. In some embodiments, the upper boundary in the pH value is defined by the regime where turnover or decomposition (decomplexation) of one or more other components of the reaction composition is noticeable. In some embodiments, a suitable pH value of the reaction composition is one which is greater than the pKₐH value for the first protonation (pKₐH₁) of the catalyst/ligand complex, i.e., pKₐH₁<pH of the reaction composition. Depending on the components of the reaction composition, pH could be, e.g., 11, 10, 9, 8, 7, or 6, or any non-integer therebetween. The catalyst/ligand complex coordinates strongly in this range. The inventors believe that at pH below pKₐH₁ the protonation of the catalyst/ligand complex is responsible for (partially) deactivating the complex, though some catalytic activity may still be maintained. Decreasing the pH further may lead to a second protonation of the ligand. This occurs at pH corresponding to the second pKₐH value (pKₐH₂), causing further reduced stable kinetics of the surface polymer formation.

In an embodiment of the present disclosure, control of pH in the reaction composition is done by addition of at least one pH control agent capable of adjusting or maintaining the pH of the reaction composition in the desired pH range. It is to be understood, that the pKₐH values of the catalyst/ligand complex depends on the nature of the catalyst and the ligand. In an embodiment where Cu is used as catalyst and tris[2-(dimethylamino)ethyl]amine (Me₆TREN) is used as ligand, the at least one pH control agent may maintain the pH of the reaction composition above pKₐH₁=8.4. In another embodiment where Cu is used as catalyst and Me₆TREN is used as ligand, then at least one pH control agent may maintain the pH of the reaction composition between pKₐH₁ and pKₐH₂ as defined herein from 8.4 to 4.1. In a third embodiment where Cu is used as catalyst and N,N,N′,N″,N″′-pentamethyldiethylene-triamine (PMDETA) is used as ligand, the at least one pH control agent may maintain the pH of the reaction composition above pKₐH₁=8.6. In a fourth embodiment where Cu is used as catalyst and PMDETA is used as ligand, the at least one pH control agent may maintain the pH of the reaction composition between pKₐH₁ and pKₐH₂ as defined herein from 8.6 to 3.4. In a fifth embodiment where Cu is used as catalyst and tris(2-pyridylmethyl)amine (TPMA) is used as ligand, the at least one pH control agent may maintain the pH of the reaction composition above pKₐH₁=7.4. In a sixth embodiment where Cu is used as catalyst and TPMA is used as ligand, the at least one pH control agent may maintain the pH of the reaction composition between pKₐH₁ and pKₐH₂ as defined herein from 7.4 to −0.4. The upper boundary in the pH value is defined by the regime where turnover or decomposition of one or more components of the reaction composition is noticeable. In some embodiments, the upper boundary in the pH value is 13. Thus, in some embodiments, the pH of the reaction composition should be above 6. Preferably, in some embodiments, the pH of the reaction composition should be between 8 and 12. The pKₐ values of certain copper-ligand complexes are summarized in Table 1. The pKₐ values of certain copper-ligand complexes are summarized in Table 1. The pKₐH₂ values of these complexes were confirmed by UV/Vis spectroscopic analysis to be the pH where protonation causes the characteristic absorbance profile of the catalyst/ligand complex to disappear, meaning that the complex is not, at that pH, a stable species. The pKₐH₂ values of other catalyst/ligand complexes not included in Table 1 may be determined analogously.

TABLE 1
Catalyst/ligand complex pKₐH₁ and pKₐH₂ values as determined.

| Ligand | Catalyst/ligand complex | pKₐH₁ | pKₐH₂ |
|---|---|---|---|
| Me₆TREN | Cu/Me₆TREN | 8.4 | 4.1 |
| PMDETA | Cu/PMDETA | 8.6 | 3.4 |
| TPMA | Cu/TPMA | 7.4 | −0.4 |
| TREN | Cu/TREN | 9.4 | 3.5 |

By way of example, when Cu is used as catalyst and Me₆TREN is used as ligand, it has been shown (cf. Example 12) that at pH below pKₐH₁, where the Cu/Me₆TREN complex is protonated, the rate of surface polymerization decreases. Furthermore, the formation of bulk polymers increases (vide infra) which appears to erode the kinetics and lifetime of the surface polymer formation. These aspects underline the beneficial effect of controlling the pH in view of the pKₐ values of the catalyst/ligand complex.

In an embodiment of the present disclosure, control of the concentration of dissolved O₂ in the reaction composition is done by addition of at least one oxygen control agent capable of maintaining the concentration of dissolved molecular O₂ in the reaction composition below a desired boundary. In one embodiment, the oxygen control agent chemically removes O₂ dissolved in the reaction composition, thereby controlling the molecular oxygen concentration in the reaction composition. The chemical removal of O₂ may suitably be done by a substance with oxygen scavenging properties. Oxygen scavenging is here understood to be the continuous consumption of molecular oxygen which is dissolved in the reaction composition. It is presently believed that the principal reaction pathway responsible for the beneficial oxygen scavenging is a reduction reaction; that is, the oxygen scavenger may be a substance capable of reducing molecular oxygen dissolved in the reaction composition.

Non-limiting examples of molecular oxygen control agents are oxygen scavengers such as sodium ascorbate (NaAsc), ascorbic acid (Asc), hydrazine, hydrazine hydrate, sodium thiosulfate, sodium sulfite, sodium dithionite, glucose with GOₓ, or pyrogallic acid. In some embodiments, the roles of catalyst activator and oxygen control agent are fulfilled by a single substance, e.g., by adding the catalyst activator in excess amount, thereby providing full catalyst activation while also achieving the oxygen control effect.

In another embodiment, the oxygen control agent physically removes O₂ in the reaction composition. The physical removal of O₂ may suitably be done by purging with an inert gas such as argon or nitrogen or by vacuum degassing.

The amount of O₂ in the reaction composition may be measured and expressed by a partial pressure. A specific partial pressure in hPa relates to a concentration in M through Henry's law. Information needed to convert a partial pressure p(O₂) to a molar concentration [O₂] includes Henry's solubility parameter (Hₛ^{cp}) for a given species in a given solution (for O₂ in H₂O at rt, Hₛ^{cp}=1.3·10⁻³ M atm⁻¹), the partial pressure of the species, the temperature of the medium (due to the temperature dependency of equilibrium constants) and ionic strength of the medium (due to a typically decreasing gas solubility at higher salinities). For binary solvent mixtures, the Henry's law solubility parameter is dependent on the individual Hₛ^{cp} values for the individual solvents on their pure form, as well as an interaction parameter of the solvents derived from Wohl expansion of excess chemical potential. (Note: 1 hPa corresponds to 1 mbar.)

The concentration of O₂ (amount of dissolved O₂) in the reaction composition is thus related to p(O₂) (the partial pressure of O₂) in the reaction composition. For a given reaction composition as defined herein, p(O₂) should not exceed 25 hPa, i.e., the oxygen control agent should be added in an amount so as to keep p(O₂) below 25 hPa or at 25 hPa during surface polymer formation. The amount of oxygen dissolved in a reaction composition can be measured in hPa using a sensor with a sensitivity within this range. Within the present context, the amount of oxygen dissolved in the reaction composition may also be referred to as “concentration of 02” or “partial pressure of 02”.

Depending on the solubility of the oxygen control agent in the particular reaction composition, different oxygen control agents may be used. By way of example, sodium ascorbate or sodium thiosulfate may be more suited for aqueous reaction compositions, whereas hydrazine may be more suited for non-aqueous reaction compositions.

As mentioned above, the amount of molecular O₂ dissolved in the reaction composition should preferably not exceed 25 hPa in order to maintain stable kinetics during the surface polymer formation. It is believed this minimizes oxidation of the active catalyst/ligand complex to its oxidized deactivating form. Controlling the molecular oxygen concentration affects the equilibrium between the activating catalyst/ligand complex and its oxidized deactivating form and provide an improved control over the rate of surface polymerization. To initiate the surface polymer formation, the activating catalyst/ligand complexes react with polymerization initiators to generate propagating radicals, that undergo polymerization with monomers. On the other hand, the oxidized deactivating form of the catalyst/ligand complex may react with propagating radicals and form capped dormant species. Dissolved O₂ present in the polymerization composition will oxidize the activating catalyst/ligand complex to its oxidized deactivating form and thereby change the equilibrium between activating catalyst/ligand complex and the oxidized deactivating form, and thereby hamper surface polymerization. The catalyst activator on the other hand continuously (re)generate the activating catalyst/ligand complex from the oxidized deactivating catalyst/ligand complex. Due to the high rate with which the activating catalyst/ligand complex may be consumed through oxidation by O₂, continuous generation of the activating catalyst/ligand complex facilitated by the catalyst activator may be entirely counteracted by the presence of O₂, incapacitating the surface polymerization which is dependent on activating catalyst/ligand complex. Besides, O₂ may also react with active radical chain ends (propagating radicals) and quench the polymerization. Hence, by ensuring the partial pressure of O₂ dissolved in the reaction composition does not exceed 25 hPa, stable kinetics during the extended lifetime of the reaction composition can be obtained.

In some cases, the oxygen control agent may react with O₂ present in the reaction composition and form H₂O₂·H₂O₂ may further react in a metal-catalyzed Fenton-like reaction (see J. Catal. 2013, 301, 54-64.) to generate OH radicals that initiate polymerization in the bulk of the reaction composition. The bulk polymer formation is undesirable, as it (a) alters the reaction composition and ultimately may reduce the activity and the lifetime of the reaction composition and (b) increases the likelihood that post-cleaning will be needed due to “stickiness” of the bulk polymer to the substrate. By keeping the partial pressure of dissolved oxygen from exceeding 25 hPa, the formation of H₂O₂ is minimized, and hence also the undesirable bulk polymer formation. An example of a H₂O₂ generating oxygen control agent is sodium ascorbate in combination with a Cu catalyst. Importantly, in cases where one or more processes in the reaction composition may continuously and rapidly consume dissolved O₂, the reaction composition may be kept and operated under ambient atmosphere which contains O₂ with no loss in surface polymerization ability.

In cases where H₂O₂ is generated as mentioned above, another reason to keep the pH of the reaction composition within a certain pH range, is that H₂O₂ generated may be decomposed to H₂O and O₂ instead of OH radicals at alkaline conditions. Accordingly, at alkaline conditions the extent of OH radical formation is diminished, and bulk polymerization initiated by OH radicals is ultimately diminished. Thus, it may be beneficial to use a reaction composition comprising both a pH control agent and an oxygen control agent. Accordingly, in an embodiment, the polymerization control agent is a pH control agent and an oxygen control agent. In particular, the polymerization control agent may be sodium ascorbate which functions both as pH control agent and oxygen control agent.

By controlling the pH>pKₐH₁, the surface polymer formation rate may be kept high and uniform, and the rate of bulk polymer formation may be kept low. Both factors are important for ensuring an extended lifetime of the reaction composition (timeframe during which surface polymers may be formed on a substrate without addition to and/or removal of components from a given bath). At pKₐH₁>pH>pKₐH₂, the kinetics of the surface polymerization can be kept stable.

Controlling or limiting polymerization which is not surface-initiated polymerization, but bulk polymerization, resulting in polymeric material which is not covalently linked to a substrate surface is desirable. Bulk polymerization entails aspects which are detrimental to the surface polymerization, including (1) consumption over time of components of the reaction composition which are required for surface polymer formation; (2) changes over time in physical parameters of the reaction composition, such as viscosity, which may impact surface polymer formation kinetics over time; and (3) chemisorption or physisorption of bulk polymer chain to the growing surface polymer inducing formation of inhomogeneous surface polymers. In terms of (1), bulk polymer formation consumes monomer, which is usually present in finite amounts, possibly leading to a deficiency in monomer availability over time, and thus leading to a reduction in the rate of surface polymer formation. In terms of (2), the formation of bulk polymer in the reaction composition may lead to an increase in viscosity of the reaction composition, which then impacts the rate of diffusion-controlled chemistry occurring in the reaction composition, complicating the aspect of maintaining a uniform performance of the reaction composition over time. Bulk polymer which is poorly solubilized by the reaction composition furthermore entails mechanical issues, like clogging of the system. Ultimately, this leads to lack of process control sufficient to ensure consistent and repeatable manufacturing in HVM environment. In terms of (3), bulk polymer chains may be physisorbed onto the substrate surfaces, thereby impacting the substrate-liquid interface e.g. by reducing the diffusion of monomer and catalyst to the growing chain ends ultimately leading to a slower rate of surface polymer formation. In addition, growing bulk polymer chains may also react (couple) to propagating surface polymer chain ends. This may impact the resultant surface polymer, where surface polymer chains are of different chain lengths, resulting in an inhomogeneous surface polymer.

A general method for assessing the extent of bulk polymer formation is the measurement of turbidity using a turbidity sensor in nephelometric turbidity units (NTU). Actions to avoid bulk polymer formation may also be taken to keep turbidity below 500 NTU throughout the lifetime of the reaction composition.

Due to the detrimental effects described above, limiting the rate and extent of bulk polymer in the reaction composition may be beneficial, depending on components of the reaction composition. Accordingly, the reaction composition may further comprise at least one radical inhibitor. It is currently believed that free radical polymerization is a contributor to the formation of bulk polymer. Non-limiting examples of such inhibitors include MEHQ (4-methoxyphenol), butylated hydroxytoluene, 4-tert-butylcatechol (TBC), butylated hydroxytoluene (BHT), hydroquinone (HQ), dinitro-ortho-cresol, di-nitro-sec-butylphenol (DNBP), phenothiazine, 2-(hydroxyamino)propanohydroxamic acid (HPHA), and diethylhydroxyamine (DEHA) as well as combinations thereof. Radical inhibitors may react with radical chain ends to terminate polymerization, and therefore it can be advantageous to add radical inhibitors to the reaction composition to hamper polymerization of bulk polymer. Radical inhibitors may also react with radicals of growing surface polymer chain ends, and thereby may terminate the surface polymer formation. By keeping the concentration of radical inhibitors low—such as 2 ppm or 20 ppm—this undesired impact on the surface polymer formation can be minimized. Radical inhibitors are normally present in commercially available monomers to stabilize monomer. An alternative way of removing any bulk polymers may be by filtration of the reaction composition at suitable times. It is, however, preferred to minimize the formation of bulk polymers, instead of needing to repeatedly remove bulk polymers from the reaction composition.

H₂O₂ may also be chemically removed to reduce bulk polymer formation using a hydrogen peroxide scavenger. Examples of hydrogen peroxide scavengers include horseradish peroxidase and sodium pyruvate. Additionally, OH radicals generated from H₂O₂ (in metal-catalyzed Fenton-like reaction) may also be quenched. Examples of OH radical scavengers include alcohols like mannitol and n-butanol.

The reaction composition according to embodiments of the present disclosure comprises at least one catalyst activator. The catalyst activator is responsible for the turnover between oxidized deactivating and/or activating catalyst states. It is presently believed that the principal reaction pathway for catalyst activation is reduction; that is, the catalyst activator is a species which is capable of reducing the catalyst. Examples of suitable catalyst activators are oxygen scavengers such as sodium ascorbate, ascorbic acid, hydrazine, hydrazine hydrate, sodium hypophosphite, glucose, tin 2-ethylhexanoate, sodium phenoxide, sodium dithionite, and a mixture of iron powder and sodium chloride.

The catalyst of the reaction composition as defined herein may be based on a transition metal (as defined in the Periodic Table of Elements). Suitable examples of transition metals comprise compounds derived from copper (Cu), iron (Fe), aluminum (Al), cadmium (Cd), tungsten (W), rhenium (Re), ruthenium (Ru), platinum (Pt), titanium (Ti), manganese (Mn), nickel (Ni), samarium (Sm), or palladium (Pd). In an embodiment, the catalyst is based on transition metals derived from Cu and/or Fe species. Specific examples of such catalysts include Cu₂O, CuO, CuCl, CuCl₂, CuBr, CuBr₂, FeO, Fe₂O₃ and Fe₂O₄ as well as combinations thereof. In a preferred embodiment the catalyst is based on Cu. In one embodiment, the Cu concentration in the reaction composition is in the range 0.001-1 mM. The concentration of Cu in the reaction composition is preferable in the range 0.02-0.32 mM, for example 0.02 mM, 0.04 mM, 0.08 mM, 0.16 mM, or 0.32 mM. The activator for the catalyst (e.g., oxygen scavenger) may be used in excess compared to the transition metal. Excess activator may, e.g., be 10-250 times. In accordance with the methods disclosed herein, catalyst activator may be added several times during surface polymer formation to control surface polymer formation with progressing time.

The reaction composition according to embodiments of the disclosure comprises at least one ligand which may form a complex with the catalyst. The activity of the catalyst can be modulated by electron-rich smaller organic molecules capable of coordinating to a redox-active metal atom of the catalyst. Thus, suited ligands are such which are bi-, tri- or tetradentate aromatic and aliphatic amines. One, two, or three ligands may form complexes with one transition metal catalyst. A confirmation of the presence of a specific catalyst/ligand complex may in many cases be obtained using UV/Vis spectroscopic analysis, as such complexes typically feature characteristic absorption profiles in the UV/Vis region. Such UV/Vis spectroscopic analysis is exemplified in Example 8 (vide infra). It is currently believed that the catalyst/ligand complex, and not either individual species, is the primary species which is responsible for catalyzing the surface polymer forming ability of the reaction composition. In one embodiment, at least one ligand is a nitrogen-containing compound. Non-limiting examples of such nitrogen-containing compounds are bi-, tri-, or tetradentate amine ligands (containing two, three or four amine substituents) which are aliphatic and/or aromatic in nature. In particular, such ligands include ligand is selected from N,N,N′,N″,N″′-pentamethyldiethylene-triamine (PMDETA), tris[2-(dimethylamino)ethyl]amine (Me₆TREN), tris(2-aminoethyl)amine (TREN), tris(2-pyridyl-methyl)amine (TPMA), 1,1,4,7,10,10-hexamethyltriethylenetetramine (HMTETA), tetramethylethylenediamine (TMEDA), 1,4,8,11-tetramethyl-1,4,8,11-tetraazacyclotetradecane (Me₄Cyclam), and 2,2′-bipyridyl (BiPy) and combinations thereof. The amount of ligand in the reaction composition is defined as a ratio to the concentration of catalyst in the reaction composition. The ratio of ligand to catalyst in the reaction composition is in the range 0.001:1-1000:1. The ratio of ligand to catalyst in the reaction composition is preferable in the range 0.005:1-100:1, for example 0.13:1, 0.5:1, 1.0:1, 2.0:1, 3.5:1, 7.5:1 or 12:1. In general, excess amount ligand as compared to amount catalyst is preferred.

In one embodiment, the catalyst is copper (Cu). The formed active catalyst/ligand complex is Cu(I)/L and the oxidized inactive form is Cu(II)/L, where L denotes the ligand. The equilibrium between Cu(I)/L and Cu(II)/L is used to control the surface polymer formation, where Cu(I)/L reacts with halide initiators (R—X) attached to the surface to generate Cu(II)/L-X and propagating radicals, whereas Cu(II)/L-X and propagating radicals combine to generate halide initiators or X-capped dormant species and Cu(I)/L. The oxygen scavenging pathway (dissolved O₂ present in the polymerization composition) will oxidize the active Cu(I)/L catalyst to Cu(II)/L, and thereby change the equilibrium between activating Cu(I)/L and deactivating Cu(II)/L, and as a consequence hamper the surface polymer formation. Due to the high rate with which Cu(I)/L may be consumed through oxidation by O₂, continuous generation of Cu(I)/L facilitated by the catalyst activator may be entirely counteracted by the presence of O₂, incapacitating the surface polymer formation which is dependent on Cu(I)/L. As mentioned above, keeping the partial pressure of O₂ dissolved in the reaction composition below or at 25 hPa, stable kinetics during the timeframe for surface polymer formation events can be controlled and ensured, minimizing the formation of inactivating Cu(II)/L-X and thus the negative effect on the surface polymer formation will be de minimis.

The reaction composition according to embodiments of the present disclosure may further comprise a halide compound for increasing the “livingness” of the surface polymer formation. A “living” polymerization refers to a surface polymer formation where the rate of termination is minor in comparison to the rate of propagation of surface polymer chains (extension of a surface polymer by monomeric units). As a result, living polymer formations show a linear relationship between polymer chain length and time. A living polymer formation also allows for propagating block copolymers. The halide compound to be used herein is a compound capable of providing a halide anion. Non-limiting examples of such compounds are NaCl, NaBr, KCl, KBr, MgCl₂, MgBr₂, CaCl₂, HCl, HBr, LiCl, LiBr, CaBr₂, CuBr₂ and CuCl₂ as well as combinations thereof. Halide compounds may disassociate in the reaction composition, generating halide anions which may form complexes with and/or bind to catalysts in solution, resulting in an increased concentration of catalyst/ligand-X complexes which are responsible for end-capping, and thus deactivating, propagating surface polymer chain-end radicals to deliver alkyl halides. Consequently, the number of propagating surface polymer chain-end radicals at any given time is lowered, which may result in at least effects; (1) a lowering of the rate with which surface polymers grow initially due to a lower number of propagating chains, and (2) a lowering of the rate with which chain termination between two propagating surface polymer chain-end radicals occur (through recombination or disproportionation), leading to an increased living character of the surface polymer formation. In an embodiment, the catalyst is Cu, the ligand is Me₆TREN, PMDETA, TREN, HMTETA, TMEDA, or Me₄Cyclam and the halide compound is NaCl.

In another aspect, the present disclosure relates to a method for forming surface polymers comprising: bringing at least a portion of a polymerization initiator-modified substrate into contact with a reaction composition comprising: at least one monomer; at least one ligand and at least one catalyst, wherein the at least one ligand and the at least one catalyst form a complex; at least one catalyst activator; and at least one solvent; controlling the surface polymer formation by means of pH of and/or molecular oxygen concentration of the reaction composition; and optionally adding a at least one polymerization control agent to adjust the pH of and/or the molecular oxygen concentration of the reaction composition.

It is to be understood that the above steps may not necessarily be executed in the order as written. That is, one of the steps may in some cases be performed before or subsequent.

Thus, the polymerization control agent may (i) be added before the substrate is brought into contact with the reaction composition, (ii) be added after the substrate is brought into contact with the substrate, or (iii) when the substrate is brought into contact with the substrate. Furthermore, the polymerization control agent may be added continuously during the surface polymer formation or as discrete portions during the surface polymer formation.

The catalyst activator may suitably be added to the reaction composition (i) before the substrate is brought into contact with the reaction composition, (ii) after the substrate is brought into contact with the reaction composition, or (iii) when the substrate is brought into contact with the reaction composition.

The inventors have recognized that with the reaction method described herein, the kinetics of the surface polymer formation remains stable for surface polymer formation/propagation during an extended timeframe allowing formation of surface polymers in a continuous manner (i.e., multiple substrates or portions of substrates), in the presence of at least one polymerization control agent comprised in the reaction composition. In particular, the polymerization control agent may be a pH control agent and/or an oxygen control agent, thus, enabling control over the pH and the molecular oxygen (O₂) concentration in the reaction composition.

Allowing to form surface polymers in a continuous manner is here understood to be that the surface polymers can be formed on 2 or more substrates, which are in the reaction composition following one another; or portions of an extended substrate, where the kinetics of the surface polymerization is within +/−20%, preferably +/−15%, of the average rate on the 2 or more substrates or on several portions of an extended substrate. The ability to form surface polymers with a high degree of uniformness and reproducibility is a highly valued feature in the formation of surface polymers, both on a small and in particular larger (high-volume) scale. At least some embodiments of the present disclosure provide a method of doing so.

In an embodiment, the additional polymerization control agent is added at least once before and/or during the consecutive surface polymer formation events.

In an embodiment, the method further comprises monitoring and controlling the molecular oxygen concentration in the reaction composition and/or monitoring and controlling the pH of the reaction composition prior to or during surface polymer formation.

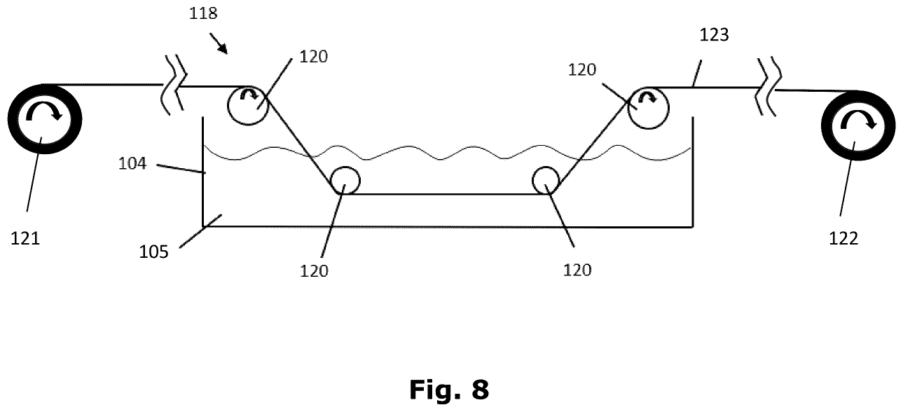

In an embodiment, the method is applied to form surface polymers on a plurality of substrates in a consecutive manner. In another embodiment, the method is applied to form surface polymers on a flexible elongated substrate which may be provided on a roll and processed using a roll-to-roll or reel-to-reel mechanism such as shown in FIG. 8.

The molecular O₂ concentration and/or partial pressure of O₂ in the solution of the reaction composition during the surface polymer formation may suitably be monitored using an O₂ sensor. If the monitoring indicates that the molecular O₂ concentration in the solution of the reaction composition increases, more oxygen control agent may suitably be supplied to the reaction composition. The oxygen control agent to be used in embodiments of the method according to the disclosure is as defined herein.

The pH of the reaction composition during the surface polymer formation may suitably be monitored using a pH meter. If the monitoring indicates that the pH of the reaction composition increases above or decreases below the desired range (threshold values), more pH control agent may suitably be supplied to the reaction composition. The pH control agent to be used in embodiments of the method of the disclosure is as defined herein.

It is to be understood that the method described herein may comprise one or more of the following: cleaning the substrate prior to or subsequent to attaching initiators; cleaning the polymerization initiator-modified substrate prior to or subsequent to forming surface polymers; annealing the substrate prior to or subsequent to attaching initiators; and
annealing the substrate prior to or subsequent to forming surface polymers.

In another aspect, the present disclosure relates to a method for forming surface polymers comprising: providing a reaction composition comprising at least one monomer; a least one ligand and at least one catalyst, wherein the at least one ligand and the at least one catalyst form a complex; at least one catalyst activator; and at least one solvent, wherein the reaction composition is held in a reaction composition container; bringing at least a portion of a first polymerization initiator-modified substrate into contact with the reaction composition in a reaction composition container thereby forming surface polymers on said first substrate; withdrawing said first substrate from the reaction composition in the reaction composition container; subsequent to the withdrawing of said first substrate, bringing at least a portion of a second polymerization initiator-modified substrate into contact with the reaction composition in the reaction composition container, thereby forming surface polymers on said second substrate; withdrawing said second substrate from the reaction composition in the reaction composition container; and optionally using at least one polymerization control agent to control the pH and/or the molecular oxygen concentration in the reaction composition. In an embodiment, the reaction composition may be modified during the surface polymer formation by addition of further components of the reaction composition, and/or removal of bulk polymer byproducts. In an embodiment, the pH of the reaction composition and/or the molecular oxygen concentration of the reaction composition may be controlled by measuring pH and/or molecular oxygen concentration during the surface polymer formation in combination with supplying at least one polymerization control agent. In an embodiment, a plurality of substrates is subjected to surface polymer formation in the reaction composition container in a consecutive manner.

In an embodiment, procedures described above may be repeated in order to form, e.g., block copolymers applying two or more different monomers in surface polymerization events.

In an embodiment, the pH of the reaction composition is adjusted to control the kinetics of the surface polymer formation. The terms “kinetics” and “stable kinetics” are explained in more detail above.

In an embodiment, the method described above may comprise one or more of the following: cleaning the substrate prior to or subsequent to attaching initiators; cleaning the polymerization initiator-modified substrate prior to or subsequent to forming surface polymers; annealing the substrate prior to or subsequent to attaching initiators; and annealing the substrate prior to or subsequent to forming surface polymers.

In particular, at least one polymerization control agent as defined herein may be added prior to, during or following the surface polymer formation. However, other components of the reaction mixture may also be supplied, e.g., additional monomer, during the course of surface polymer formation. In some embodiments, the reaction component may be adjusted to receive subsequent substrates for surface polymer formation.

In an embodiment, an amount of oxygen control agent is added to the reaction composition to keep the molecular O₂ partial pressure in the solution from exceeding 25 hPa. The oxygen control agent may suitably be added once or several times, the number of times being dependent on the measured molecular O₂ partial pressure. For example, if a supply over time of additional molecular O₂ originates from an external source, such as an molecular O₂-containing atmosphere (ambient atmosphere) consumes the amount of oxygen control agent initially added, spiking of (i.e., addition of further) oxygen control agent to the reaction composition may be performed to maintain a steady molecular O₂ concentration in the solution corresponding to a partial pressure of molecular O₂ which is below the herein defined target partial pressure of molecular O₂ of 25 hPa. Evaluation of the conditions of such spiking may be based on continuous measurements of the concentration and/or partial pressure of dissolved molecular O₂ in the reaction composition, such as with a dedicated oxygen sensor.

With addition of/spiking with further oxygen control agent at a given time, the concentration of molecular O₂ dissolved in the reaction composition may be maintained to increase the lifetime of the reaction composition for surface polymer formation, thus, enabling a plurality of surface polymer formation events in a consecutive manner.

In an embodiment, an amount of pH control agent is added to the reaction composition to reach the herein defined target range of pH value “x” (x>pKₐH₁ of catalyst/ligand complex or pKₐH₁>x>pKₐH₂).

With addition of/spiking with further pH control agent, the pH value of the reaction composition may be maintained to increase the lifetime of the reaction composition for surface polymer formations, thus, a plurality of surface polymer formation events in a consecutive manner.

The expression “at least one” as used throughout the disclosure herein is intended to include one or multiple components of reaction mixture, polymerization control agent, substrates, or portions of extended substrates. There is no limit to the number of substrates as long as the reaction composition is active for formation of surface polymers.

Other parameters may be monitored to control and accordingly adjust the reaction composition and thereby kinetics of the surface polymer formation. Without limitation, such parameters include temperature, turbidity, conductivity, and chemical parameters measured for example by spectroscopy and spectrophotometry.

The reaction composition comprises at least one solvent. The solvent may be any solvent that provides sufficient solubility of the components of the reaction composition. Suitable solvents include but are not limited to: alcohols; dipolar aprotic solvents (for examples, tetra-hydrofuran, methyl acetate, ethyl acetate, butyl acetate, dimethyl sulfoxide, dimethyl formamide); methylene carbonate; ethylene carbonate; propylene carbonate; ethyl lactate alcohol; toluene ionic liquids; supercritical CO₂; and water, as well as mixtures thereof.

Non-limiting examples of appropriate monomer types include anionic, cationic, zwitterionic, protic and aprotic monomers, and include acrylates; methacrylates; halogen-substituted alkenes; acrylamides; methacrylamides; and styrenes, as well as mixtures thereof. The generic monomer structure comprises a polymerizable part (an alkenyl group), which in certain embodiments is connected to a functional group responsible for the specific functionality (e.g., adhesion, permeability, electric and ionic conductivities) of the certain monomer through a certain linker chemistry.

For acrylate monomers, non-limiting examples of functional moieties include but are not limited to: alkyl groups; sulfonates; fluorosulfonates; carboxyls; metal carboxylates; ethers; poly(ether) groups; bis(sulfonyl)amides; fluorinated sulfonates; perfluoroalkyl carboxylate; borate; fluorinated borate; borate ester derivatives; tetraphenylborate; bis(trifluoromethane)-sulfonimide; triflimides and derivatives thereof; halogenated alkyl chains; and mono-, di-, and tri-alkoxy silanes.

The polymerizable part and the functional part of monomer can, in certain embodiments, be connected by linker moiety. Non-limiting examples of appropriate linker chemistries include but are not limited to: alkyl chains; esters; ethers; poly(ethers); amines; amides; aryls; and any combination(s) thereof. Non-limiting examples of appropriate acrylate monomers containing alkyl linkers include but are not limited to: methyl acrylate; ethyl acrylate; and lauryl acrylate. Non-limiting examples of monomers using ether and poly(ether) linker chemistry include but are not limited to: poly(ethylene glycol) methyl ether acrylate; and poly(ethylene glycol) acrylate. Non-limiting examples of monomers without linker chemistry include but are not limited to: acrylic acid; and lithium acrylate; and sodium acrylate.

For methacrylate monomers, non-limiting examples of appropriate functional moieties include but are not limited to: carboxylic acids; metal carboxylates; esters; alkyl alcohols; oxiranes; linear and branched alkyl groups; sulfonates; fluorosulfonates; bis(sulfonyl)amides; fluorinated sulfonates; perfluoroalkyl carboxylate; borate; fluorinated borate; borate ester derivatives; tetraphenylborate; bis(trifluoromethane)sulfonimide; triflimides, and derivatives thereof; halogenated alkyl chains; and mono, di, and tri-alkoxy silanes.

Non-limiting examples of linker chemistries include but are not limited to: alkyl chains; esters; ethers; poly(ethers); amines; amides; aryls; and any combination(s) thereof.

Non-limiting examples of methacrylate monomers include but are not limited to: methacrylic acid; lithium methacrylate; sodium methacrylate; methyl methacrylate (MMA); potassium 3-sulfpropyl methacrylate; 2-hydroxyethylmethacrylate (HEMA); glycidyl methacrylate (GMA); ethyl methacrylate; n-butyl methacrylate; tert-butyl methacrylate; lauryl methacrylate; 4-methyl-3-oxopent-4-en-1-yl 1,1,2,2,3,3,4,4,4-nonafluorobutane-1-sulfonate and 3-(N-((trifluoromethyl)sulfonyl)sulfamoyl)propyl methacrylate; potassium 3-(methacryloyl-oxy)propane-1-sulfonate; 1H,1H,2H,2H-heptadecafluorodecyl methacrylate (HFDMA); 2-((triethoxysilyl)oxy)ethyl methacrylate; and 2-(3-(triethyoxsilyl)propoxy)ethyl methacrylate.

Non-limiting examples of appropriate halogen-substituted alkene monomers include but are not limited to: vinyl chloride; vinylidene difluoride; tetrafluoroethylene; chlorotrifluoro-ethylene; and hexafluoropropylene.

Non-limiting examples of appropriate acrylamide monomers include but are not limited to: acrylamide; N-iso-propylacrylamide; N-tert-butylacrylamide; and N-hydroxyethyl acrylamide.

Non-limiting examples of appropriate methacrylamide monomers include but are not limited to: N-iso-propylmethacrylamide; methacrylamide; N-tert-butylmethacrylate; and N-hydroxyethyl methacrylamide.

Non-limiting examples of appropriate styrene monomers include but are not limited to styrene; 4-methylstyrene; 2,3,4,5,6-pentafluorostyrene; p-divinylbenzene; 4-chlorostyrene; sodium 4-vinylbenzenesulfonate; lithium 4-vinylbenzenesulfonate; and 4-vinylphenyl 1,1,2,2,3,3,4,4,4-nonafluorobutane-1-sulfonate.

Monomer(s) may be chosen to provide compatibility/adhesion/elasticity, as appropriate for a specific application. Monomer(s) can also be selected to enhance or diminish electrical and/or ionic conductivity, and/or permeability. Monomers may be chosen to improve interface stability of a surface in question.

Monomer(s) may suitably be used in an amount corresponding to a percentage relative to the remaining components of the reaction medium, such as from 0.5 to 50 vol % or from 0.5 to 50 wt %. For example, a liquid monomer may constitute e.g. 0.5 vol %, 2 vol %, or 10 vol % of the reaction composition. For example, a solid monomer may constitute, e.g., 0.5 wt %, 2 wt %, or 10 wt % of the reaction composition. In each application, an amount of monomer may be chosen to provide a desired polymer formation kinetics, solubility of the monomer, and cost of the monomer.

As mentioned above, the reaction composition for forming surface polymers as disclosed herein is viable for surface polymer formation for a prolonged period of time (timeframe). Thus, the reaction composition is re-usable for forming surface polymers on a number of subsequent substrates or portions of substrates. The prolonged period of time may suitably be up to 6 hours or more. It has further surprisingly been shown that with the reaction composition according to embodiments of the disclosure, surface polymers can be formed on the surface of a substrate with uniform thickness for an extended period of time. Accordingly, a major number of substrates or, alternatively, an elongated flexible substrate may be subjected to surface polymer formation within the lifetime of the reaction composition. The number of substrates depends on the polymerization time as well as the lifetime of the reaction composition. By way of example, a substrate may be in contact with the reaction composition from 10 seconds to 60 minutes. The prior art has failed to provide such re-usable reaction compositions.

In a particular embodiment of the present disclosure, the surface polymer is a polymer brush. Throughout the disclosure herein, the term “surface polymer” may also include polymer brush.

In accordance with an aspect of the present disclosure there are provided systems for forming the aforementioned surface polymers on a polymerization initiator-modified substrate. In other words, on a substrate that has been treated with a polymerization initiator, thus, forming polymerization initiating sites on at least a portion of the substrate. For example, a surface of the substrate on which it is desired to form the aforementioned surface polymers, has been subjected to polymerization initiator modification. The polymerization initiators enable surface polymers to form on the substrate when it is subsequently brought into contact with the aforementioned reaction composition. For present purposes it is immaterial where the polymerization initiators are applied to the substrate, provided that this is done prior to bringing the substrate into contact with the reaction composition. In some embodiments it is envisaged that the substrates may be pre-coated with the polymerization initiator and provided to the system comprising the polymerization initiator coating. In other embodiments it is envisaged that application of the polymerization initiator coating may occur within the system, and suitable apparatus may be provided to achieve this where needed.

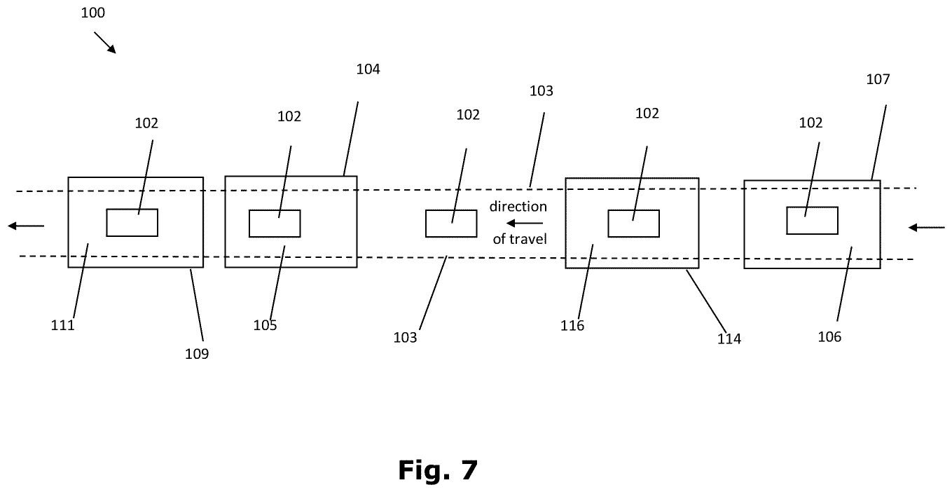

FIG. 7 is a non-limiting schematic illustration of a system 100 for forming surface polymers on at least a portion of a substrate. The system 100 comprises a reaction composition container 104 containing the aforementioned reaction composition 105. Container 104 may relate to any vessel or chamber suitable for holding the reaction composition. At least a portion of a polymerization initiator-modified substrate 102 is brought into contact with the reaction composition 105, for example by at least partly immersing a desired surface of substrate 102 into the reaction composition, thereby enabling surface polymers to form on the substrate.

Optionally, system 100, may comprise one or more further containers, each container comprising different compositions and/or agents for treating the substrate 102, either prior to the substrate being brought into contact with the reaction composition 105, or afterwards. Where substrate 102 has not been pre-treated with a polymerization initiator, then the system 100 may further comprise a container 106 holding a polymerization initiator chemistry 107, thus, forming the polymerization initiator-modified substrate 102 in the container 106.

FIG. 7 relates to an embodiment in which the substrate has been pre-coated with a polymerization initiator. In such embodiments, and as illustrated in FIG. 7, a cleaning container 114 may be provided, comprising a cleaning agent or cleaning device 116. The cleaning agent/device 116 may be used to clean the surface of substrate 102 prior to bringing it into contact with reaction composition 105 held by the reaction composition container 104. This may be achieved by, at the very least, subjecting at least a portion of the substrate 102 on which it is desired to form surface polymers on, to cleaning procedures in container 114 using cleaning agent/device 116. In this way, any impurities which may interfere with the formation of the surface polymers, are removed from the surface of substrate 102, prior to bringing substrate 102 into contact with the reaction composition 105. System 100 may additionally include a substrate displacement device 103 for bringing the substrate 102 at least partly into contact with the reaction composition 105 held by the reaction composition container 104 for a controlled time to ensure surface polymers form. The displacement device 103 may be used to remove the substrate 102 from the reaction composition 105 following surface polymer formation. Thus, the substrate displacement device 103 may be configured to maintain the surface of substrate 102 at least partly in contact with the reaction composition 105 to enable surface polymers to form on at least a portion of the surface of the substrate, and the substrate displacement device 103 may be configured to maintain the substrate 102 in contact with the reaction composition 105 for a predetermined amount of time.

In embodiments where the system 100 may comprise two or more containers, such as illustrated in FIG. 7, in addition to bringing substrate 102 into contact with the compositions contained by each container, the substrate displacement device 103 is configured to transport substrate 102 to and from each container. For example, as illustrated in FIG. 7, the substrate displacement device 103 is configured to first transport substrate 102 into contact with cleaning agent/device 116 in container 114, and/or a polymerization initiator composition 107 if the substrate is not pre-coated with a polymerization initiator as mentioned previously, held in the polymerization initiator container 107, and subsequently to transport the substrate 102 from the polymerization initiator container 107 to the reaction composition container 104, where the substrate is brought at least partly into contact with the reaction composition 105 held by the reaction composition container 104. In the latter example, the substrate may in embodiments be cleaned between initiator coating and surface polymer formation.

The substrate displacement device 103 may relate to any device capable of transporting the substrate from one container to another container. For example, the substrate displacement device 103 may relate to a mechanical device. In particular, it is envisaged that the substrate displacement device 103 may comprise any one of: a conveyor system; a programmable mechanical arm; and/or a roll-to-roll processor/mechanism.

A conveyor system as used herein may refer to a mechanical system that is used to move a material, such as the substrate, which in embodiments may be in a substrate holder on its own or with other substrates, from one process container to another, typically comprising a movable conveyor, powered by a drive system and having a series of rollers or pulleys that support and guide the belt. In use, the substrate may be placed on the conveyor which passes the substrate through the one or more containers comprised in the system. In this way, as the conveyor is powered, the substrate is passed through the component(s) held by each container within the system.

In some embodiments a programmable mechanical arm, such as a robotic arm, may be used to transport the substrate, which may be in a holder as described above.

A roll-to-roll processor or mechanism is particularly advantageous for use where the substrate may be flexible and elongated, such as a cable, wire, foil, or any other elongated flexible substrate. FIG. 8 illustrates such an embodiment, in which the substrate displacement device relates to a roll-to-roll processor 118, comprising a sending roll 121, a receiving roll 122 and a plurality of rollers 120. At least some of the rollers 120 and the receiving roll 122 are driven, thereby enabling a flexible elongated substrate 123 to be passed from sending roll 121 through the reaction composition 105 in container 104 to the receiving roll 122. The roll-to-roll mechanism can be utilized as a replacement to the substrate displacement device 103 in FIG. 7 when elongated flexible substrates are being processed.

In yet further embodiments, at least one of the plurality of containers may comprise an annealing oven for annealing the formed surface polymers. In a similar manner as described previously, the substrate displacement device 103 may be configured to transport the substrate with the formed surface polymers to the annealing oven 109 and to bring the substrate with surface polymers into position for annealing. The annealing oven is equipped with a heating device for annealing the formed surface polymers and the gas environment 111 in the oven may be controlled as needed—for example, to avoid oxidation by using only non-oxidizing gases.

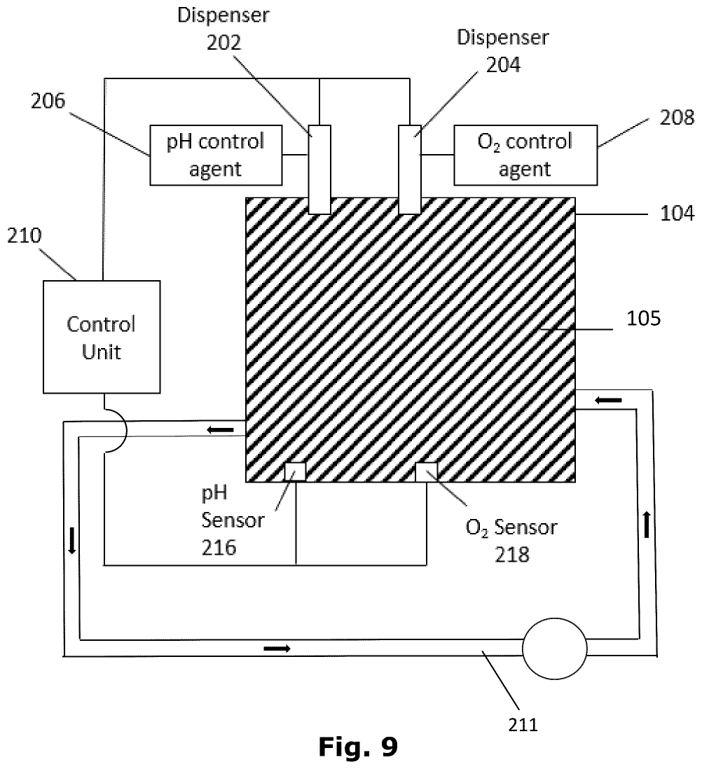

FIG. 9 is a more detailed schematic illustration of the reaction composition container 104 containing the reaction composition 105 of FIG. 7 or FIG. 8, in accordance with an embodiment. The reaction composition container 104 may be equipped with one or more sensors. The one or more sensors may be configured to measure a characteristic of the reaction composition 105, which characteristic may relate to a physical or chemical characteristic of the reaction composition 105, such as the pH of the reaction composition or the molecular oxygen concentration in the reaction composition. The sensor data may be used to determine whether a value of the measured characteristic lies within a predetermined threshold for the surface polymer formation process. If the measured characteristic is determined to lie outside the predetermined threshold, then the chemistry of the reaction composition may be adjusted by dispensing a polymerization control agent into the reaction composition to adjust the value of the measured characteristic. In this way, it is possible to ensure that the values of the one or more characteristics of the reaction composition are within a range suitable for forming surface polymers on the substrate. A control unit operatively connected to the one or more sensors, may be used to control one or more dispensers for dispensing one or more control agents to control the chemistry of the reaction composition, for example a rise in pH can be corrected by dispensing acid into the reaction composition 105 in the container 104. The measured characteristic may relate to any one of the aforementioned physical or chemical characteristics of the reaction composition.

Similarly, the chemistry of the reaction composition may be adjusted by dispensing any one or more of the components of the reaction composition into the reaction composition. For example, the components may relate to any one or more of: at least one monomer, at least one ligand, at least one catalyst, at least one catalyst activator, and at least one solvent. In some embodiments, the control unit may be configured to output a control signal for controlling operation of a dispenser for dispensing one or more components of the reaction composition into the reaction composition, in response to the measured characteristic of the reaction composition, or in response to an observed time variance of the characteristic. For example, a value of the measured characteristic may be monitored over a time period using the one or more sensors. The control unit may determine to output a control signal to control operation of one or more dispensers to dispense the one or more components on the basis of an observed variation over time of the measured characteristic. The observed variation may be indicative that the chemistry of the reaction composition is varying such that the surface polymer formation process is falling out of specification—for example, surface polymer formation is reduced and/or compromised. The dispensing of one or more components of the reaction composition into the reaction composition may help to maintain one or more chemical properties of the reaction composition, to enable the formation of surface polymers.

In some embodiments, dispensing of the one or more control agents and/or components of the reaction composition may occur periodically. In such embodiments, sensor measurement data may be used to ensure the chemical and/or physical characteristics of the reaction composition are as desired. However, dispensing of the one or more control agents and/or components of the reaction composition, and more specifically the outputting of one or more control signals by the control unit to control the dispensers, may be independent of any specific sensor measurement. (The latter method of maintaining the reaction composition can be based on known rates of consumption of components of the reaction composition or on known variation over time of pH or molecular oxygen concentration, for example.) In yet further embodiments, dispensing of the one or more control agents and/or components of the reaction composition, and more specifically the outputting of one or more control signals by the control unit, may be directly dependent on one or more measured characteristics of the reaction composition. Similarly, the outputting of one or more control signals by the control unit to control dispensing of the one or more control agents and/or components of the reaction composition may be dependent on a measured sensor signal indicative of a change in a measured characteristic of the reaction composition. Combinations of some of these different methods may also be advantageous, for example using dispensing of agents and/or components for maintenance of the reaction composition over shorter time intervals without use of sensor measurements, combined with adjustments being made based on regular sensor measurements made at longer time intervals.

For non-limiting purposes only, the illustrated examples in FIGS. 9 through 11 illustrate embodiments where the control unit outputs one or more control signals for controlling one or more dispensers, dependent on a measured sensor signal indicative of a predetermined threshold value associated with a characteristic of the reaction composition not being met.

With reference to FIG. 9 and in accordance with some embodiments, the reaction composition container 104 may comprise a pH sensor 216 operatively coupled to a control unit 210. The pH sensor 216 may consist of a probe or electrode that is inserted into the reaction composition 105 to be measured. The pH sensor 216 and control unit 210 may be used to determine if the pH of the reaction composition 105 is within a suitable range for surface polymer formation. For example, the control unit 210 may be programmed to determine if the pH value of the reaction composition measured by the pH sensor 216 is below a predetermined threshold at which surface polymer formation can still take place. In some embodiments, the pH threshold may be selected as being equal to or greater than a pKₐH value of the catalyst ligand complex used in the reaction composition 105. For example, in some embodiments the predetermined pH threshold value may be equal to or greater than the pKₐH₁ value of the catalyst ligand complex. In yet further embodiments, the pH threshold may relate to a preferred range. For example, less than or equal to pKₐH₁ and greater than or equal to pKₐH₂.

The control unit 210 may be configured to control the operation of one or more chemical agent dispensers 202, 204. For example, one of the dispensers may relate to a pH control agent dispenser 202, configured to dispense a volume of pH control agent 106 into the reaction composition 105. The control unit 210 may control the operation of the one or more dispenser 202, 204 via one or more output control signals. For example, the pH control agent dispenser 202 may be configured to dispense the pH control agent 206 into the reaction composition 105 dependent on receipt of a pH control signal from control unit 210. Control unit 210 may be configured to output the pH control signal when a pH sensor signal indicative of the pH of the reaction composition 105 being below the predetermined threshold is received by the control unit 210. Adding a pH control agent to the reaction composition 105 adjusts the pH of the reaction composition 105. In this way, by adding pH control agent to the reaction composition 105 when the pH changes relative to the threshold value, it is possible to control the pH of the reaction composition 105 and to ensure that it remains in a range suitable for formation of surface polymers on substrate 102 with the desired kinetics.

In some embodiments, the reaction composition container 104 may also comprise a molecular O₂ sensor 218 operatively coupled to a control unit 210. The molecular O₂ sensor 216 may consist of a probe or electrode that is inserted into the reaction composition 105 to be measured. The molecular O₂ sensor 218 and control unit 210 may be configured to determine if the molecular oxygen concentration of the reaction composition 105 is above a predetermined threshold value. The predetermined threshold value may be chosen as the molecular oxygen concentration threshold above which the reaction composition's 105 ability to form surface polymers is compromised. For example, in some embodiments the threshold value may be less than or equal to 25 hPa. The molecular O₂ sensor 218 may be operatively coupled to the control unit 210 in a similar manner to the pH sensor 216. Control unit 210 may be configured to output an oxygen control signal to an oxygen control agent dispenser 204, when the molecular O₂ sensor signal indicative of the molecular oxygen concentration of the reaction composition 105 being greater than the predetermined threshold is received by the control unit 210 from the molecular O₂ sensor 218. Dispensing an oxygen control agent, such as any one of those mentioned herein (e.g. sodium ascorbate), into the reaction composition 105 helps to reduce the molecular oxygen concentration within the composition. By selectively dispensing an oxygen control agent into the reaction composition 105 when the molecular oxygen concentration exceeds a desired threshold value, it is possible to maintain the molecular oxygen concentration of the reaction composition 105 within the desired range, which facilitates the formation of surface polymers and the stable kinetics of the surface polymer formation.

With reference to FIG. 9 and in accordance with some embodiments the reaction composition container 104 may comprise a recirculation circuit 211 including a pump, or other device to provide efficient mixing of the reaction composition to help ensure any dispensed control agents are more uniformly distributed in the reaction composition 105 and around the substrate(s). In other embodiments, other mechanical or ultrasonic mixing may be applied. The recirculation circuit may comprise a filter for removing particulates and bulk polymer should they be present in the reaction composition; in other embodiments, filters may be positioned in parts of the container other than the recirculation circuit, where there is a good circulation of reaction composition.

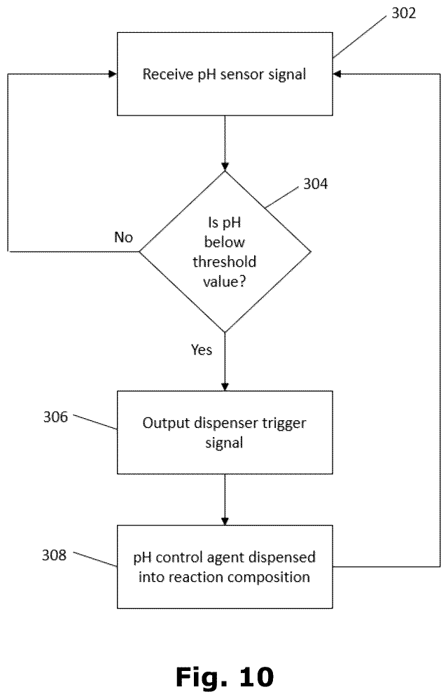

FIG. 10 is a process flow chart illustrating an exemplary method that may be carried out, in accordance with an embodiment, by control unit 210 of FIG. 9 to control operation of the pH control agent dispenser 202. A pH sensor signal is received by control unit 210, at step 302. If the pH sensor signal is determined, at step 304, as being indicative of the pH of the reaction composition 105 being less than the predetermined pH threshold value, as recited previously, then control unit 210 generates and outputs a pH control agent dispenser trigger signal, at step 306. In turn, this causes the pH dispenser 202 to dispense the pH control agent into the reaction composition 105, at step 308. In some embodiments it is envisaged that control unit 210 may receive pH sensor signals on a periodic basis. Accordingly, in such embodiments if it is determined, at step 304, that the received pH sensor signal is not indicative of the pH of the reaction composition 105 being below the pH threshold, then control unit 210 simply waits for receipt of a pH sensor signal indicative of the pH being below the threshold to control operation of the pH control agent dispenser 202.

Steps 302 through 308 may be iteratively repeated until the measured pH of the reaction composition 105 is greater than or equal to the predetermined pH threshold value. For example, in certain embodiments the pH control agent dispenser 202 may be configured to dispense a predetermined dose (e.g., volume) of pH control agent upon receipt of the first control signal from control unit 210. However, in some scenarios, multiple doses of pH control agent may be needed to increase the pH of the reaction composition 105 to the pH threshold value or more, in which case steps 302 through 308 are iteratively repeated until a sufficient number of doses of pH control agent have been dispensed into the reaction composition 105 to reach the pH threshold value or more.

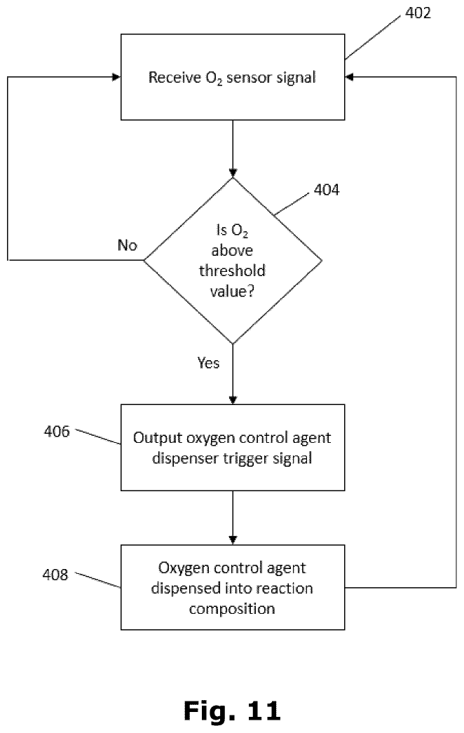

FIG. 11 is a process flow chart illustrating an exemplary method that may be carried out, in accordance with an embodiment, by control unit 210 of FIG. 9 to control operation of the oxygen control agent dispenser 204. An O₂ sensor signal is received by control unit 210, at step 402. If the received O₂ sensor signal is determined, at step 404, as being indicative of the molecular oxygen concentration of the reaction composition 105 being greater than the predetermined oxygen threshold value, as disclosed previously, then control unit 210 generates and outputs an oxygen control agent dispenser trigger signal (e.g., the second control signal), at step 406. In turn, this causes oxygen control agent dispenser 204 to dispense the oxygen control agent 208 into the reaction composition 105, at step 408. If it is determined, at step 404 that the molecular oxygen concentration is not above the predetermined threshold, then control unit 210 simply waits for receipt of an O₂ sensor signal that is indicative of the molecular oxygen concentration being greater than the predetermined threshold value to control operation of the oxygen control agent dispenser 204.

In a similar way as disclosed in relation to FIG. 10, steps 402 through 408 may be iteratively repeated until the measured oxygen value of the reaction composition 105 is less than or equal to the predetermined molecular oxygen concentration. In some embodiments, oxygen control agent dispenser 204 may be configured to dispense a predetermined dose (e.g., volume) of oxygen control agent 208. In some scenarios it is envisaged that multiple doses of oxygen control agent 208 may need to be dispensed to reduce the molecular oxygen concentration of the reaction composition 105 to the predetermined molecular oxygen concentration or less, in which case steps 402 through 408 may be repeated until a sufficient number of doses have been dispensed to reduce the molecular oxygen concentration of the reaction composition 105 to the predetermined molecular oxygen concentration or less. In some embodiments, the oxygen control agent dispenser 204 may be configured to dispense a predetermined dose of oxygen control agent 208 into the reaction composition 105 at predetermined times, e.g., when a substrate is brought into contact with the reaction composition 105.

In some embodiments it is envisaged that the control unit may be configured to output dispenser control signals as the value of the relevant measured characteristic of the reaction composition approaches the predetermined threshold value. This enables the relevant control agent to be dispensed into the reaction composition before the value of the relevant characteristics falls outside the predetermined threshold.

In some embodiment the control agent dispensers may be configured to implement a variable dosing regimen in which, for example, the dose of control agent to be dispensed is proportional to the measured value of the characteristic of the reaction composition.

Whilst FIGS. 10 and 11 disclose embodiments in which monitoring of the oxygen and pH characteristics of the reaction composition occur independently, it is to be appreciated that the plurality of characteristics of the reaction composition may be monitored in combination. Furthermore, it is to be appreciated that the dispensing of control agents into the reaction composition may impact two or more characteristics of the reaction composition. For example, dispensing of an oxygen control agent may impact the pH of the composition, and similarly dispensing of a pH control agent may impact the molecular oxygen concentration of the reaction composition.

In some embodiments it may be advantageous to control the environmental conditions in which the system is implemented, and in particular in which the surface polymers are formed. For example, this may help to reduce contaminants and other impurities contaminating the reaction composition and/or the substrate. Similarly, controlling environmental conditions such as, but not limited to, pressure, temperature, humidity, and/or inert atmosphere, may be beneficial to the process for forming surface polymers. To achieve this, in some embodiments, the system may be implemented in an environmentally controlled chamber. For example, the aforementioned containers may sit within one or more environmentally controlled chambers. In some embodiments all of the containers may sit within one or more chambers. In some embodiments a subset of the containers may sit within one or more chambers. For example, it is envisaged that in some embodiments the polymerization initiator container may sit within a chamber, whilst the reaction composition container, may sit outside a chamber. Similarly, in some embodiments it is envisaged that cleaning of the substrate prior to polymerization initiator formation may also occur in an environmentally controlled chamber, in which case the associated cleaning agent container also sits within an environmentally controlled chamber.

Whilst the system of FIG. 7 is illustrated as comprising four containers comprising a reaction composition, a cleaning agent or cleaning device, initiator chemistry and an annealing oven it is to be appreciated that the system may comprise any number of containers, more or less than shown, comprising a plurality of different components and/or agents for treating the substrate. In particular, it is envisaged that the system may comprise a plurality of containers comprising a plurality of cleaning agents. Similarly, the system may comprise one or more annealing containers, configured to anneal the substrate at different stages in its processing, that is prior to attachment of polymerization initiators, prior to surface polymer formation and/or subsequent to surface polymer formation.

In accordance with some embodiments, both cleaning and/or annealing containers may be positioned to treat the substrate at different stages, including for example prior to or after polymerization initiator application, and prior to or after surface polymer formation.

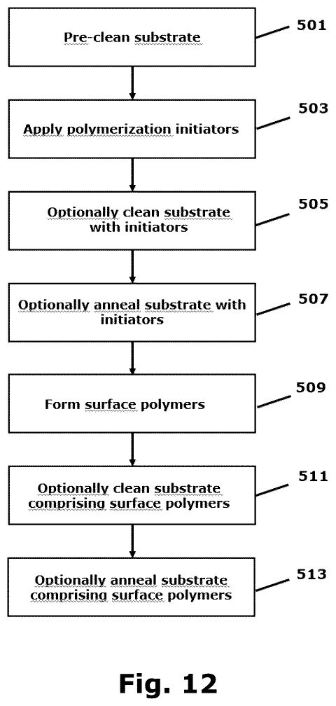

FIG. 12 is an exemplary process flow chart illustrating the different stages at which the substrate may be cleaned and/or annealed. The system may comprise an initial cleaning stage in which the substrate is cleaned by bringing it into contact with a cleaning agent or cleaning device comprised in a cleaning container, as described previously, at step 501. Examples of cleaning agents include HF and piranha solution to chemical etch surface oxides and organic contaminants; organic solvents to remove organic contaminants, by-products, and residual process chemicals; and water, acids, and bases to remove inorganic contaminants, by-products, and residual process chemicals. Examples of cleaning devices include ovens and vacuum ovens for thermal cleaning; ultrasonic baths for ultrasonic cleaning; electro-cleaning devices; and spray cleaning devices. This may be followed by the application of polymerization initiators to the portion of the substrate on which it is desired to form the surface polymer, at step 503. This may be achieved, as described previously, by bringing the portion of the substrate on which it is desired to form the surface polymers into contact with a polymerization initiator agent, for example vaporized initiator or a solution containing an initiator. Once the polymerization initiators have been formed, the polymerization initiator-modified substrate may optionally be cleaned, by bringing it into contact with a cleaning agent, at step 505; and/or may be optionally annealed, at step 507. Annealing may be carried out as described previously. At step 509, the portion of the substrate on which it is desired to form the surface polymers may be brought into contact with the reaction composition to form surface polymers on the desired portion of the substrate, as described previously. Following the formation of the surface polymers on the portion of the substrate, the substrate, and more specifically the formed surface polymers may be optionally cleaned, using a cleaning agent, at step 511; and/or may be optionally annealed, at step 513. Accordingly, the system configured to carry out all the steps of FIG. 12 may comprise a plurality of cleaning containers each comprising a cleaning agent; a plurality of annealing containers equipped with annealing components/devices. Accordingly, it is to be appreciated that the process of cleaning and/or annealing the substrate may occur before and/or after polymerization initiation; and before and/or after surface polymer formation.

In yet further embodiments, it is envisaged that the cleaning agent may be applied to the desired portion of the substrate using an applicator, such as, but not limited to, a spraying device. In such embodiments, it is envisaged that the substrate displacement device may be configured to simply bring the substrate into range of the applicator, such that the applicator may apply the cleaning agent to the desired portion of the substrate. The applicator may be connected to a reservoir containing the cleaning agent.

In accordance with some embodiments, the system may comprise one or more additional containers containing compositions for forming one or more additional layers or blocks of surface polymers on the substrate. Accordingly, it is envisaged that each layer or block of surface polymer formed on the substrate may be formed by bringing the desired portion of the substrate into contact with a reaction composition comprising a different monomer. In this way multiple layers of surface polymer may be formed. The different layers may relate to the same surface polymers, in which case the different containers may contain reaction composition with same monomer, or the different layers may relate to different surface polymers, in which case the reaction compositions held in the different containers contain monomer different from the first. In some embodiments, so-called random surface polymer may be formed. Random surface polymer can be formed applying a reaction composition with multiple different monomers. Random surface polymer may be formed either as first surface polymer layer or further surface polymer layer.

Some embodiments may comprise a post-treatment container containing a post-treatment agent, and wherein the substrate displacement device is configured to bring the desired portion of the substrate into contact with the post-treatment agent. In some embodiments, post-treatment may comprise post-treatment of formed surface polymers, to convert certain chemical functional groups in surface polymers to other chemical functional groups or to crosslink chemical functional groups in a surface polymer to chemical functional groups in a neighboring surface polymer. Examples of relevant chemical reactions in the post-treatment include deprotection of a protected carboxylic acid, nucleophilic substitution, ring-opening reactions, and anion exchange. In other embodiments, post-treatment may comprise infusion with nano- or micro-particles into the surface polymers. Nano- and microparticles may be inorganic species.

In some embodiments, the system may comprise a drying device configured to dry the substrate prior to or after bringing the substrate into contact with the compositions held in any one of the containers comprised in the system. The drying may be achieved, e.g., by air blowing or by heating.

Some embodiments may comprise an etching container containing an etching agent, and wherein the substrate displacement device is configured to bring the desired portion of the substrate into contact with the etching agent. In some embodiment, etching may comprise an etching device for etching patterns on the substrate. Etching may suitably be by plasma etching or HF etching.

In yet further embodiments, the containers comprised by the system may comprise one or more devices for performing measurements or metrology on the substrate prior to or following each procedure in the surface polymerization, and in particular on the formed surface polymers. Such measurements include, but are not limited, to any one or more of: measuring, removing and analyzing by-products and/or reaction composition components, measuring thickness of the formed surface polymers, and/or measuring the size of particulate bulk polymers formed by filtering off bulk polymers.

In accordance with some embodiments, the reaction composition container may comprise one or more further sensors configured to measure characteristics of any one of the following components of the reaction composition: solvent, monomer, ligand, catalyst, catalyst activator.

In accordance with some embodiments, the system may comprise a plurality of reaction composition containers configured in parallel, such that a plurality of different substrates may be prepared with surface polymers in parallel.

In some embodiments, the reaction composition container may comprise a recirculation device, configured to circulate components of the reaction compositions, in particular during and/or after dispensing of the one or more polymerization control agents. This may improve the dissemination of the polymerization control agent within the reaction composition. See for example recirculation circuit 211.

Further examples of sensor that may be provided in the reaction composition container are: conductivity measuring devices, turbidity measuring devices, electrochemical measuring devices, potentiostatic devices. Furthermore, the reaction composition container may further be provided with any one or more of the following devices: ultrasonication devices, temperature controlling devices, UV light generating devices, inert atmosphere generating devices, IR light generating devices. Such devices may assist in monitoring, controlling and/or optimizing the formation of surface polymers on the substrate. Furthermore, the reaction composition container may be configured with one or more dispensers configured to dispense any agent for supplementing reagents (e.g., monomer, ligand, catalyst, catalyst activator, and/or solvent) in the reaction composition. Such dispenser may in some cases comprise a mixing station for mixing prior to dispersing any solutions into a container. One or more sensors may also be incorporated to measure different parameters.

The one or more containers may comprise a sealing device (e.g., a lid) for reducing evaporation of the held compositions, and/or reducing possible interaction with the ambient atmosphere. The one or more containers may comprise means for inert gas purge to reduce explosion risks or minimize interaction of the various compositions with the ambient atmosphere. The inert gas purge may, e.g., be applied through a bubbler to increase dew points.

Any one of the containers may comprise sample ports for taking samples of the compositions held in the containers for analysis using external equipment.

Some methods for preparing a substrate for surface polymer formation have been described in the art. A brief description of the usually used processes is given herein. However, it is to be understood that alternative processes may also be suited and workable within the context of the present disclosure.

### Attachment of Polymerization Initiators:

Firstly, polymerization initiators are attached (“immobilized”) on the surface of the substrate onto which the surface polymers are to be formed. Polymerization initiators are covalently bonded to the surface of the material, see, e.g., WO 2014/0075695. The polymerization initiators may be provided with a predefined surface chemistry to enable attachment onto the surface of the material, depending on the nature of the material, but also depending on the characteristics of the surface polymer to be formed. Non-limiting examples of suitable chemistries for attaching polymerization initiators on treated surfaces include but are not limited to: aryl diazonium salts; organosilanes; organothiols; organophosphonic acids; organophosphornates; catechols; iodonium salts; alkenes; alkynes; and sol-gel coatings. Surface anchored polymerization initiators can be prepared as multilayer films or monolayer films. Monolayer films can be densely packed (full monolayer coverage) or partly packed, covering all or only a part of the available surface. The density of the initiator film dictates the density of the subsequently formed surface polymer. Density would be understood by persons of ordinary skill as the percentage of the available substrate area covered by polymerization initiators.

The attachment of polymerization initiators usually follows a 1-step or a 2-step process. The 1-step process applies grafting of benzyl halide (like benzyl chloride) or secondary or tertiary halide moieties onto the surface of the substrate either by diazonium or silane grafting. The benzyl halide and secondary and tertiary halide moiety act as the polymerization initiator for the following surface-initiated polymerization. The 2-step process usually applies surface grafting of an initial organic compound with a nucleophilic group, and in a second step using the nucleophilic group to attach an initiator moiety. The nucleophilic group may include a hydroxyl or amine group. Then, the nucleophilic group is reacted with an electrophile to add an initiator moiety, forming a covalent bond between the two. The initiator group can again be e.g., benzyl halide and tertiary halide moieties.

The attachment process is further described below:

### Silane Grafting 1-Step:

Initiators can be attached on a surface in one step by silane grafting of trialkoxysilane with benzyl halide or tertiary halide groups. The silane grafting is normally done either by vapor deposition, in solution, by spray coating, or paint-on coating.

### Diazonium Grafting 1-Step:

Initiators can be attached on a surface in one step by grafting of aryl diazonium salts with benzyl halide groups. The diazonium grafting is normally done either by activating the aryl diazonium salt electrochemically or chemically or by letting it react spontaneously.

### Diazonium Grafting 2-Step:

Another route of initiator attachment is by a two-step process. The first step being grafting of an aryl diazonium salt or a silane that contains a nucleophilic group (alcohol or amine). In a second step a nucleophilic acyl substitution reaction adds a halogen containing group, giving the attached polymerization initiator.

Other ways of immobilizing/attaching initiators may be applied.

If only specific areas of a material surface are to be coated with polymerization initiators, the area(s) to which initiator attachment is(are) not wanted may be blocked, e.g., chemically or by using a foil, seal or cover, or etched; or masked or protected.

### Formation of Surface Polymers:

Surface polymer is then grown or formed from the surface-attached initiators upon contact with a reaction composition as defined.

Surface polymer thickness may be from 1-1,000 nm. The preferred thickness of surface polymer depends on the specific intended application and may preferably be from 1-500, 1-250 nm, 5-100 nm, 120-250 nm, 10-80 nm, or 10-30 nm thick, measured as the dry film thickness of collapsed surface polymer. The thickness refers to the dry film thickness of surface polymer formed. The dry film thickness is dependent on the density (anchoring points per area) of end bonded polymer chains and the length of the individual chains.

In certain embodiments, surface polymer layer can possess specific properties obtained through block co-polymers, random polymers, or binary mixed polymer, where two or more disparate monomers are used to grow the surface polymer in different surface polymer architectures. In such embodiments the individual components (different monomers) of block co-polymers, random polymers or binary mixed polymers can contribute different properties resulting in a surface polymer with a combination of desired properties.

Surface polymer layer can be applied or formed by repeating certain of the above steps to build up block co-polymers. The same or different monomers can be applied relative to the monomers used to form previous layers. Forming additional layers of surface polymer can be repeated multiple times to obtain a more complex or thicker surface polymer. Surface polymers can also be formed using two or more different monomers grown from one type or different types of initiators thereby forming random or mixed surface polymers, respectively. Hence, two or more functional groups (e.g., halogen atoms, hydroxyl groups, or amine groups) can be incorporated, resulting in surface polymers with a unique set of combined properties, each of which is inherent from individual monomers.

For forming surface polymers, the substrate and the reaction composition as defined herein are typically kept in contact with each other for a suitable period of time (residence time), such as from 0.1 seconds to 5 hours. The residence time includes, but are not limited to, 1 second, 2 seconds, 30 seconds, 1 minute, 5 minutes, 30 minutes, 1 hour, 2 hours, 3 hours, 4 hours and 5 hours. The surface polymer formation may take place at ambient temperature (room temperature), or with cooling or heating. Suitable temperatures are such from −20° C. up to 120° C., such as from room temperature (approximately 20° C.) to 120° C. Specific temperatures include, but are not limited to, −20° C., 0° C., room temperature (approximately 20° C.), 30° C., 50° C., 60° C., 70° C., 80° C., 90° C., 100° C., 110° C., and 120° C. The residence time and temperature during the residence time may suitably be computer-controlled. Other ways of adjusting residence time and temperature may be based on conditions in the compartment holding the reaction composition (bath conditions) and/or measurements.

### Substrates for Surface Polymer Formation:

It is expected that a wide range of different substrate will be useful in connection with the disclosure herein, however, suited substrates should provide a surface, allowing firstly attachment of polymerization initiators, and secondly formation of surface polymers from said initiator sites. The substrate includes, but is not limited to, metal (like aluminum/aluminum, steel, nickel, gold, silver, platinum, chrome, copper, iron and alloys), glass, carbon, graphite, graphene, carbon black, monoclays, ceramics, composites, plastics, and particles (like Si, metal and metal alloys). The substrate may have any size, shape and structure, including an elongated structure, and may be in the form of pieces, threads, fibers, cables, wires, particles, nanoparticles, monolayers etc.

As used herein, the terms “a substrate” and “the substrate” are intended to include both a single substrate and a plurality of substrates in any form and shape.

Surface polymers may suitably be formed on a portion of a substrate or on all surfaces available on a substrate. Surface polymers may be formed on available surfaces at the same time (e.g., in the case of single-piece substrates) or on available surfaces in a sequential manner (e.g., in the case of fibers, threads, wires etc.).

Aspects and embodiments of the disclosure are further illustrated by the following, non-limiting examples.

### EXAMPLES

Throughout the examples, DI-water refers to tap water deionized using the deionizing equipment (Silhorko with M22-F softening plant, RO B1-2 Reverse Osmosis plant and Silex 2BS mixed bed plant) installed at RadiSurf's premises in Denmark. The DI-water has a conductivity of <0.5 μS, indicating an ultrapure quality with very low presence of ions. The quality of the DI-water is confirmed at least weekly. DI-water holds a conductivity of less than 0.5 μS, indicating very low presence of ions, below 0.1 mg/L.

### Example 1

### Pre-Cleaning of Silicon Wafers

This example describes a procedure for pre-cleaning of substrates for surface polymer formation. The total number of substrates may vary depending on the later application.

Silicon wafer substrates (r=5.08 cm, cut to ¼^{th} of a wafer, Test CZ—Si wafer, 4 inch, thickness=525±25 μm, (100), p-type (Boron), purchased from MicroChemicals GmbH) were cleaned prior to further processing using the following method:

Racks containing the substrates were placed in an aqueous solution of ammonia (15 vol % DI-water/85 vol % ammonia, commercially available, 25% p.a. from Chemsolute, cleaning liquid) and sonicated for 10 minutes. Then, the substrates were flushed with DI-water, and sonicated in DI-water for 10 minutes. Thereafter, the racks containing the substrates were transferred to a 5% solution of ABC clean A200 (from ABC-Clean ApS) and sonicated for 10 minutes at in a Bandelin Sonorex Super RK100 sonicator (35 kHz ultrasound frequency, 80 W nominal ultrasonic power). This step was followed by flushing the substrates in DI-water (conductivity <0.5 μS) and sonicating the substrates in DI-water for 5 minutes with previously described equipment. Finally, the substrates were flushed with acetone (>99%, Chemsolute), and left to dry at room temperature.

### Example 2

Chemical Vapor Deposition of (p-Chloromethyl)phenyltrimethoxysilane

This example illustrates a procedure for covalently attaching polymerization initiators on a substrate.

Silicon wafer substrates as described in Example 1, cleaned as described in Example 1, were used for surface modification with (p-chloromethyl)phenyltrimethoxysilane (CPTMS) polymerization initiators using a chemical vapor deposition method.

The substrates were placed in a rack and placed in a vacuum oven (Faithful Vacuum Drying Oven-DZ-BCII) with 16 vials of 100 μL CPTMS (polymerization initiator liquid, commercially available, 95% grade from Gelest) at approximately 45° C. for 150 minutes. The gauge pressure was lowered to −1.0 bar, whereby the CPTMS evaporated, and the substrates were left for 150 minutes. Thereafter, the substrates were removed and placed in an oven (Binder model FD 56) at approximately 80° C. for 5 minutes to anneal the silane layer. The surface modification was verified using water contact angle (WCA) analysis on a KrUss Mobile Surface Analyzer. The water contact angle (WCA) in cases of blank and CPTMS modified Si are seen in Table 2. An increase in WCA going from blank to CPTMS, indicated that the modification was successful.

TABLE 2

| WCA, blank (°) | WCA, CPTMS (°) |
|---|---|
| 19 ± 1 | 63 ± 3 |

### Example 3

### Preparation of Reaction Composition for Surface Polymer Formation

This example illustrates the preparation of 1000 mL of a reaction composition for the method as disclosed herein.

To a glass container (container A) was added: 16 mL catalyst solution consisting of 76 μL tris[2-(dimethylamino)ethyl]amine (Me₆TREN, ligand, commercially available, ≥98% grade from abcr or Alfa Aesar), 15.924 mL DI-water, and 324 mg/l Cu(II) obtained from a solid copper source, and further 484 mL DI-water, 410 mL ethanol (96% grade from KiiltoClean), and 75 mL methyl methacrylate monomer (MMA, 99% grade containing ≤30 ppm MEHQ, from Sigma-Aldrich). In a separate glass container (container B), 4000 mg sodium ascorbate (catalyst activator, commercially available, ≥98% grade from Sigma-Aldrich) was dissolved in 15 mL DI-water. Just after being dissolved, the content of container B was mixed into container A. After 5 minutes, the liquid was used for surface polymerization.

The amounts specified herein, totaling 1000 mL, may be scaled to accommodate the preparation of smaller or larger volumes of reaction compositions.

### Example 4

### Assessment of Surface Polymer (Polymer Brush) Forming Ability (Lifetime) on a Series of Substrates Using the Method Disclosed Herein

This example illustrates a procedure for assessment of the polymer brush forming ability of the reaction composition over time. This procedure serves as a reference in subsequent examples.

Silicon wafer substrates (same grade as described in Example 1) were pre-cleaned as described in Example 1, and polymerization initiators were bonded on the surface as described in Example 2. Reaction compositions were prepared as described in Example 3.

The substrates were immersed in the reaction composition, each at a time in a continuous manner according to the following procedure. At minute 0, defined as 5 minutes after addition of (a solution of) catalyst activator (NaAsc), the first substrate was immersed into the reaction composition for 10 minutes. At minute 10, the first substrate was removed, and another substrate was immersed in the liquid for 10 minutes, without changing or adding additional components to the reaction composition. This was repeated until a total number of 12 substrates were subjected to surface polymer (polymer brush) formation for 10 minutes each, over the course of 120 minutes, in a sequential/continuous manner.

In some cases, pH of the reaction composition was measured using a pH meter (Metrohm 913 pH meter or Metrohm 914 pH/DO/Conductometer). In some cases, the partial pressure of dissolved oxygen in the reaction composition was monitored using an O₂-selective sensor (Pyroscience FireSting-GO2). The read-out partial pressure may be converted into a dissolved molecular oxygen content (concentration) given in molarity utilizing Henry's Law that relates the partial pressure to the amount of dissolved gas. These calculations may include corrections for temperature variabilities, atmospheric pressure, solvent mixtures, and/or the impact of ionic strength on the solubility of dissolved molecular oxygen or any combination thereof.

After surface polymer formation, the substrates were cleaned collectively by sonication in DI-water (grade as Example 1) for 5 minutes, followed by sonication in acetone (grade as Example 1) for 5 minutes. The substrates were allowed to dry in ambient air.

After cleaning and drying the surface polymerized substrates, the dry film thicknesses of the formed (collapsed) surface polymers were analyzed using ellipsometry (J. A. Woollam M-2000 Ellipsometer). For each substrate, the average dry film thicknesses (in nm, obtained by averaging results obtained from ellipsometric analysis of 10 different points of the silicon wafer surface) of the surface polymers formed during polymerization for 10 minutes were plotted against the time (in min) where the substrate was extracted from the reaction composition, relative to the time for addition of the first substrate to the polymerization medium. In this way, the polymer brush forming ability of the bath containing the reaction composition were evaluated in 10-minute intervals throughout the 120 minutes lifetime study. The “bath life”, or lifetime, of a given reaction composition is defined as the duration of time where surface polymers may be formed with stable kinetics, that is, where the thickness of surface polymers grown in 10-minute intervals are within +/−20% of the average thicknesses obtained throughout the lifetime of the reaction. For the reaction composition as described in Example 3, the ellipsometric data are shown in Table 3. According to the classification as described herein, the bath life for this reaction composition was determined to be ≥120 minutes.

TABLE 3

| Time | Thickness on Si |
|---|---|
| (withdrawal of substrates) | (nm) |
| 10 | 62 ± 1 |
| 20 | 55 ± 1 |
| 30 | 61 ± 1 |
| 40 | 59 ± 1 |
| 50 | 62 ± 1 |
| 60 | 62 ± 1 |
| 70 | 63 ± 1 |
| 80 | 63 ± 1 |
| 90 | 63 ± 1 |
| 100 | 63 ± 1 |
| 110 | 63 ± 1 |
| 120 | 62 ± 1 |

### Example 5

### Assessment of Sodium Ascorbate as an Oxygen Control Agent and pH Control Agent in the Reaction Composition and the Method Disclosed

This example illustrates the ability of sodium ascorbate (NaAsc) to act both as an oxygen control agent and as pH control agent, and that controlled kinetics throughout the bath life of the reaction composition are provided under these conditions. The results are compared to standard ATRP conditions, where exposure to an oxygen-containing environment is not tolerated and no pH control is exerted.

Silicon wafers were pre-cleaned as described in Example 1, and polymerization initiators were attached on the surface as described in Example 2. Catalyst solutions and reaction compositions were prepared as described in Example 3 with the amounts of components as described in Table 4. A pH meter (Metrohm 913 pH meter or Metrohm 914 pH/DO/Conductometer) and an oxygen sensor (Pyroscience FireSting-GO2) were used to continuously monitor the pH and the partial pressure of dissolved oxygen in the reaction composition.

TABLE 4
Contents of Containers A and B prior to mixing.

| | | | | Container B | |
|---|---|---|---|---|---|
| Container A | | | | Sodium | |
| | | | Methyl | ascorbate | |
| Catalyst | | | methacrylate | (catalyst | |
| solution | DI-water | Ethanol | (monomer) | activator) | DI-water |
| 1.6 mL | 48.4 mL | 41.0 mL | 7.5 mL | 400 mg | 1.5 mL |
| | | | (0.71M) | (20.2 mM) | |

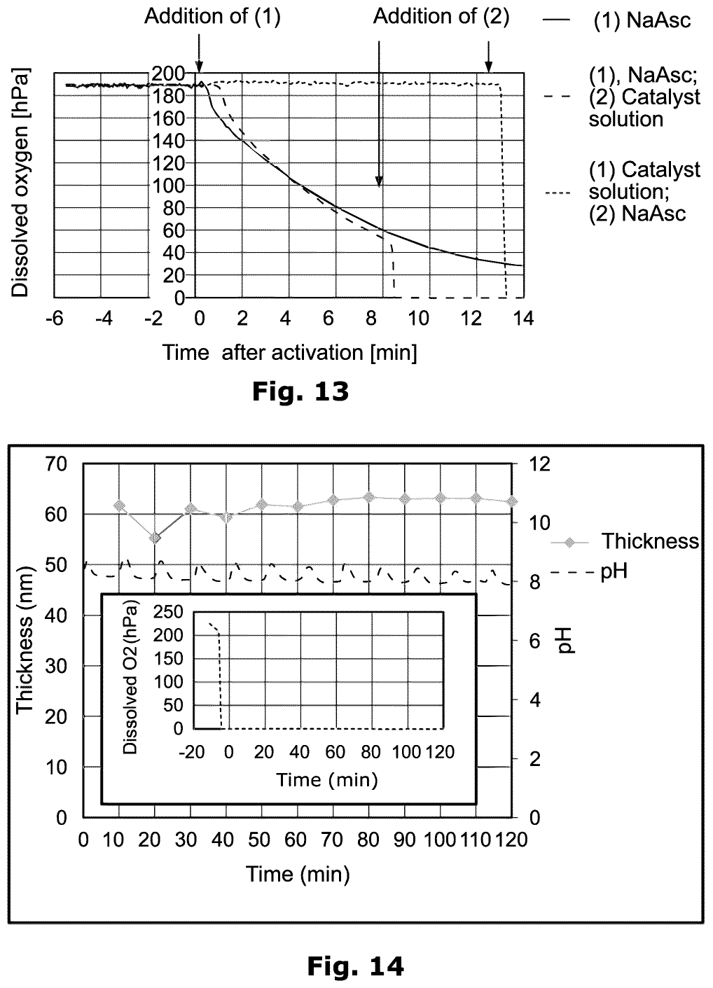

First, the concentration of dissolved molecular oxygen in combination with addition of NaAsc to the reaction composition was assessed (FIG. 13). In a solution of 48.4 mL DI-water and 41 mL ethanol (96%), the initial concentration of dissolved oxygen was established at ˜190 hPa. Upon addition of NaAsc, the molecular oxygen concentration was found to decrease over several minutes with immediate onset, eventually stabilizing after 15 minutes at ˜25 hPa. It was furthermore shown that upon addition of 1.6 mL of the catalyst solution 8 minutes after the initial NaAsc addition, the molecular oxygen concentration immediately dropped from 190 hPa to ≤1 hPa (within seconds). It is further noted that when catalyst solution was added to a solution which did not contain sodium ascorbate, no change in molecular oxygen concentration occurred; however, subsequent addition of sodium ascorbate results in a drop in molecular oxygen concentration to ≤1 hPa within seconds (FIG. 13).

Hence it is concluded that sodium ascorbate acts as oxygen control agent, with an increased effect when the catalyst/ligand complex (copper with ligand) is present. The catalyst does not act as an oxygen control agent on its own. However, the reduction of molecular oxygen by sodium ascorbate is catalyzed in the presence of the catalyst/ligand complex.

Assessment of the surface polymer (polymer brush) forming ability over time was also performed as described in Example 4 (formation of surface polymer on multiple substrate surfaces in a sequential manner) with the amounts of components as described in Table 4. The pH of the reaction composition and the partial pressure of molecular oxygen (O₂) dissolved in the reaction composition was continuously measured with the pH meter and the O₂ sensor. The obtained polymer brush thicknesses, the pH, and partial pressures of O₂ as functions of time are shown in FIG. 14.

The partial pressure of dissolved oxygen rapidly decreased from −225 hPa to <1 hPa, upon addition of sodium ascorbate to the reaction composition. The oxygen partial pressure was maintained <1 hPa throughout the 120 minutes evaluated here with just one addition of sodium ascorbate as oxygen control agent. The pH of the reaction composition was stable around pH 8, demonstrating that sodium ascorbate also acts as pH control agent at least when used in this concentration. Furthermore, using sodium ascorbate in this concentration ensured controlled kinetics throughout the surface polymer forming.

The thickness of surface polymer on the substrates was 62 nm+/−10% throughout the 120 minutes tested. From these data, it was concluded that the bath life obtained was ≥120 minutes.

In comparison, the bath life of a literature reported aqueous ATRP experiment (https://pubs.rsc.org/en/content/articlelanding/2004/jm/b312513k/unauth) was evaluated using the same setup and approach as described already in this example polymerizing glycidyl methacrylate (GMA). Silicon wafers were pre-cleaned as described in Example 1, and polymerization initiators were attached to the surface as described in Example 2. The inhibitor was first removed from the GMA, by passing it through an Al₂O₃ column. Then GMA (75 mL), MeOH (60 mL), and DI-water (15 mL) were combined in 250 mL blue cap bottle, and the solution was purged with N₂ for 15 minutes while stirring, to remove oxygen from the solution. CuCl (546 mg), CuCl₂ (59 mg) and the ligand, bipyridine (2.12 g), were added to the solution, and the solution was N₂ purged for another 5 minutes with stirring. The solution was ultrasonicated for 5 minutes to better dissolve the Cu-salts. This is referred to as the polymerization solution. Meanwhile in a separate sealed reaction container, the substrate holder containing 1 silicon wafer with polymerization initiators attached were placed and pH meter and oxygen sensor as specified above were mounted. This reaction container was purged with N₂ gas for 10 minutes to remove O₂. The polymerization solution was transferred from the blue cap flask to the reaction container via double needle to maintain an inert atmosphere. pH and the partial pressure of oxygen in the solution were continuously monitored in the reaction composition. After 30 minutes, the first substrate was removed by removing the lid maintaining a N₂ flow over the solution. Another substrate was immersed in the liquid without changing or adding additional components to the reaction composition and the container was resealed for 30 minutes. This was repeated until a total number of 4 substrates were subjected to surface polymer (polymer brush) formation for 30 minutes each, over the course of 120 minutes, in a sequential/continuous manner. Post cleaning and film thickness measurements were done as described in Example 4.

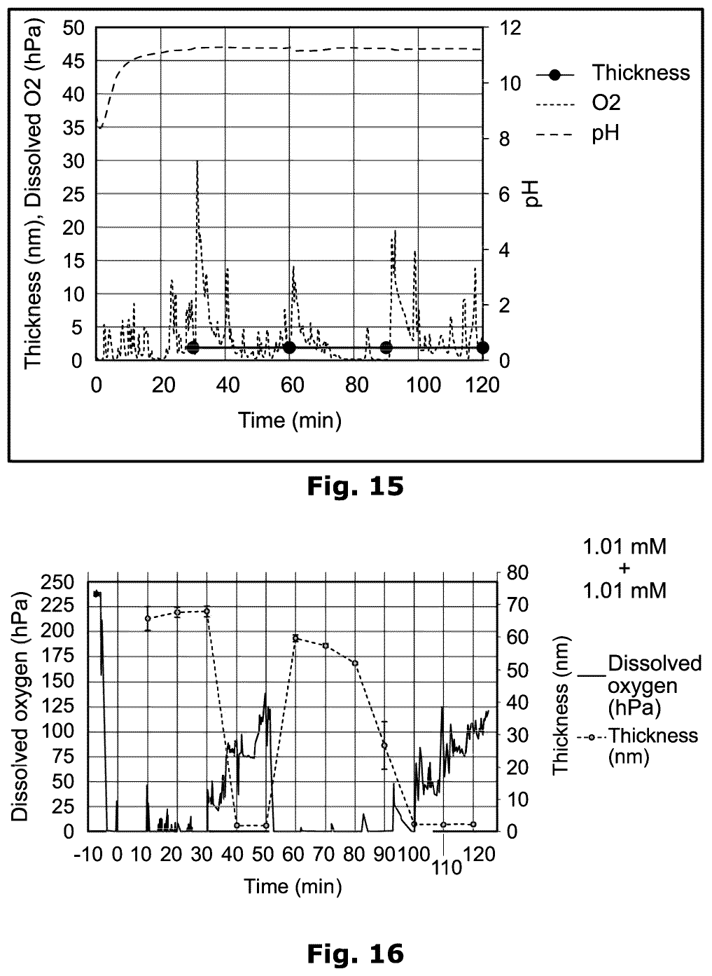

The pH in the reaction composition started at pH ˜8.5 and steadily increased to 11.2 in the first 20 minutes and stayed at that until the experiment was ended after 120 minutes (FIG. 15). The partial pressure of dissolved O₂ was <5 hPa throughout the experiment except from spikes observed especially when exchanging substrates, reaching a maximum of 30 hPa. The dry film thickness was ˜1.9 nm for all four substrates (FIG. 15) corresponding to the thickness of the Si-oxide combined with initiator film. Hence it was concluded that no surface polymers (brushes) were formed when attempting to facilitate classic ATRP in a setup that does not have strict oxygen control, when neither pH or oxygen control agents were added.

### Example 6

### Demonstrating Oxygen Control Using Oxygen Control Agent to Extend Bath Life and Form Surface Polymers on a Plurality of Substrates in a Continuous (Sequential) Manner (Method as Disclosed Herein)

This example illustrates how the molecular oxygen concentration in the reaction composition can be controlled using an oxygen control agent, and how spiking of additional oxygen control agent allows for extending the bath life of the reaction composition and for creating surface polymers on multiple substrates in a continuous (sequential) manner. Sodium ascorbate is used as oxygen control agent. Sodium ascorbate is also used as catalyst activator for activating/reducing copper in the copper-ligand complex, thereby enabling formation of surface polymers.

Silicon wafers were pre-cleaned as described in Example 1, and polymerization initiators were attached to the surface as described in Example 2. The reaction composition was prepared as described in Example 3, however, using only 2 mM of sodium ascorbate divided into two 1 mM portions added at minute 0 and minute 50, respectively. Assessment of the surface polymer (polymer brush) forming ability over time was performed as described in Example 4 (formation of polymer brush on multiple substrate surfaces). Additionally, the amount of molecular oxygen (O₂) dissolved in the reaction composition was continuously measured with an O₂ sensor (Pyroscience FireSting-GO2). The obtained polymer brush thicknesses and O₂ partial pressure as functions of time are shown in FIG. 16. The partial pressure of dissolved oxygen rapidly decreased from −240 hPa to <1 hPa, upon addition of the first portion of sodium ascorbate to the reaction composition. The oxygen partial pressure was maintained <1 hPa for 30 minutes. Between 30 and 50 minutes after the first addition of sodium ascorbate, the O₂ partial pressure increased to >100 hPa, demonstrating that the oxygen scavenging ability of the reaction composition declined after 30 minutes. Immediately after addition of the second portion of 1 mM sodium ascorbate at minute 50, the amount of dissolved O₂ reassumed to ≤1 hPa. This partial pressure was maintained in minutes 50-90, before again increasing up to >100 hPa.

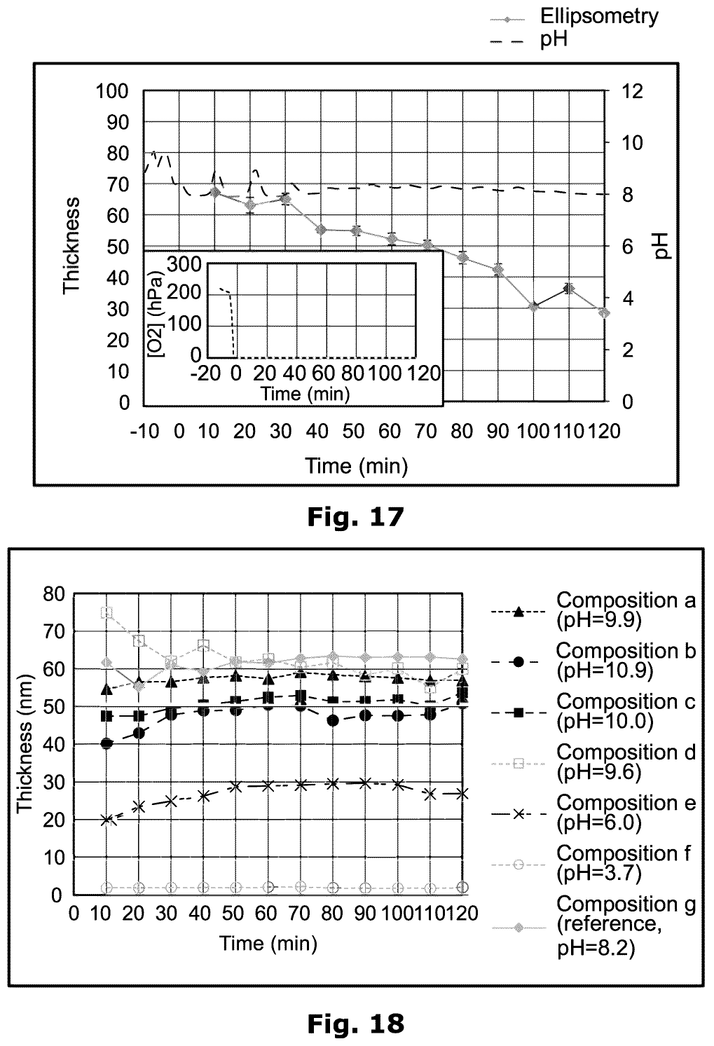

The knowledge obtained from this study allowed for defining timepoints for spiking with sodium ascorbate (additions of portions of sodium ascorbate) as oxygen control agent which, in the described setup, maintain a constantly low amount of O₂ in solution: Following the procedure as described above, but with a total of three additions of sodium ascorbate (1 mM) at minutes 20, 50, and 80, resulted in a reaction composition which contained a stable, low amount of 02 in all 120 minutes after the initial addition to activate the catalyst, and this composition was furthermore capable of facilitating surface polymer formation in the entire period (shown in FIG. 17).

Because sodium ascorbate is consumed in the process responsible for oxygen scavenging, these data show a direct correlation between a decreasing amount of the employed oxygen scavenger (sodium ascorbate) and an increasing amount of O₂ dissolved in the reaction composition over time.

The dry film thicknesses saw a decrease in surface polymer forming ability of the reaction composition when the molecular oxygen concentration increased. At molecular oxygen concentrations corresponding to a partial pressure >25 hPa, no surface polymers were formed. Hence, the molecular oxygen concentration should be kept below, or at least equal to, this limit to maintain the activity of a reaction composition for an extended timeframe.

In comparison to Example 5, it was furthermore shown that decreasing the concentration of sodium ascorbate reduced the bath life (lifetime) of the reaction composition. With an initial loading of 1 mM sodium ascorbate (FIG. 16), the O₂ partial pressure was stable for 30 minutes, and polymerization stopped after this duration, while it was shown that with an initial loading of 20.2 mM sodium ascorbate (FIG. 14 from Example 5), the O₂ partial pressure was stable at <1 hPa for at least 120 minutes, and surface polymers of 62 nm+/−10% was formed throughout the 120 minutes.

These data show a direct correlation between the amount of O₂ dissolved (oxygen partial pressure) in the reaction composition and the surface polymer forming ability of the reaction composition. Specifically, when controlling the partial pressure of dissolved oxygen <25 hPa using an oxygen control agent, the lifetime of the reaction composition may be prolonged significantly and further allowing for continuous formation of surface polymers.

### Example 7

### Use of pH Control Agent for Surface Polymer Formation and for Maintaining Bath Life of the Reaction Composition

In this example, the usability of a pH control agent for controlling the kinetics and formation of surface polymers are demonstrated.

Silicon wafer substrates were pre-cleaned as described in Example 1, and polymerization initiators were attached to on the surface as described in Example 2. The reaction composition was prepared as described in Example 3, with the amounts of each component as shown in Tables 5 and 6 below, however, with pH control attained either by exchanging the DI-water in the reaction composition with a pH buffer solution (pH control agent) or acidification by adding methanesulfonic acid (MSA, commercially available, ≥99.0% grade from Sigma-Aldrich) in DI-water, providing different pH values of the reaction composition.

TABLE 5
Components (c, concentration) present in Container A
prior to mixing with Container B.
Container A

| | | | Monomer |
|---|---|---|---|
| | | | (methyl |
| Catalyst solution | pH control agent | Ethanol | methacrylate) |
| 16 mL | See Table 6 | 410 mL | 75 mL |
| c(Cu) = 0.081 mM | 484 mL | | |
| c(Me₆TREN) = 0.29 mM | | | |
| Ratio, | | | |
| c(Me₆TREN):c(Cu) = 3.5:1 | | | |

TABLE 6
Specific pH control agents (type and mL) of
Container A for reaction compositions a-g.

| Reaction composition | pH control agent |
|---|---|
| a | Carbonate-bicarbonate buffer (pH 9.9) |
| b | Carbonate-bicarbonate buffer (pH 10.9) |
| c | Glycine buffer with NaOH (pH 10.0) |
| d | CHES* buffer (pH 9.6) |
| e | 225 μL MSA in 484 mL water (pH 6.0) |
| f | 1300 μL MSA in 484 mL water (pH 3.7) |
| g (reference) | 484 mL DI-water |

*The CHES buffer is a Good's buffer.

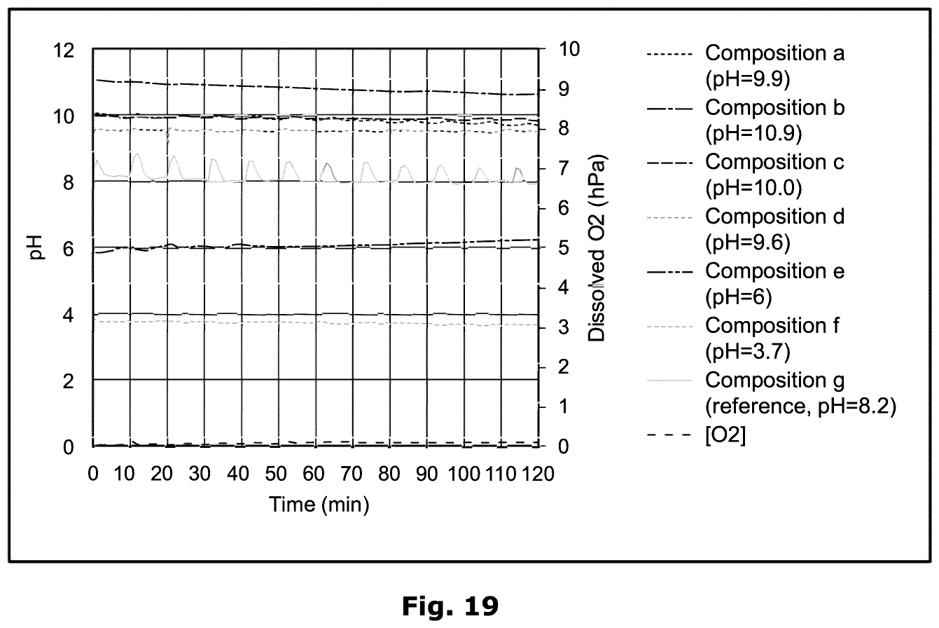

For each of the reaction compositions a-f (Tables 5 and 6), the use of a pH control agent for controlling the pH and polymer-forming ability of the reaction composition were investigated. These were then compared to a composition prepared as described in Example 3 with no supplemental pH control agent added (composition g). For each reaction compositions a-g, assessment of the polymer brush forming ability over time was performed as described in Example 4, with continuous pH measurements performed by a pH meter (Metrohm 913 pH meter) immersed in the reaction composition throughout the reaction time. For reaction composition e and g, the O₂ partial pressure measurements performed by an oxygen sensor (Pyroscience FireSting-GO2). For each reaction composition, the dry film thicknesses and measured pH values were plotted as a function of time (FIGS. 18 and 19).

Stable polymerization kinetics were obtained throughout the 2-hour bath life for all reaction compositions a-e and g, thus, demonstrating the high stability of the kinetics provided using a pH control agent. It is worth noting that in the reference system (g), sodium ascorbate acts as the buffering system (due to the high concentration thereof), maintaining pH around 8 which is expected as sodium ascorbate functions as pH control agent. Also, in the reaction compositions of e and g, the partial pressure of dissolved oxygen was ˜0 hPa throughout the bath life. Given that all reaction compositions have the same concentration of sodium ascorbate (O₂ scavenger), the same low concentration of dissolved O₂ is also expected for reaction composition a-d.

Using the buffer systems of reaction compositions a-d and g, respectively, the pH of the reaction composition can be maintained above the pKₐH₁=8.1 of the Cu/Me₆TREN complex, where the kinetics of the surface polymer forming activity of the reaction composition may be maintained at a high level. Accordingly, the reaction composition may accommodate multiple sequential surface polymerization events. In the case where 225 μL MSA is added (composition e), pH=6 is between pKₐH₁ and pKₐH₂ of the Cu/Me₆TREN complex. It is noted that the kinetics in that case is particularly slower due to the protonation as pH<pKₐH₁ of the catalyst. Importantly, the reaction composition still accommodates multiple sequential surface polymerization events. In the case where 1300 μL MSA is added (composition f), pH=3.7 is below pKₐH₂ of the Cu/Me₆TREN complex. The dry film thickness was ˜1.9 nm for all substrates corresponding to the thickness of the Si-oxide combined with initiator film. For reaction conditions e and f where MSA was added, an increased amount of bulk polymer formation was observed.

These findings demonstrate that different pH control agents may be used to control the pH level of a reaction composition and shows the potential of achieving stable surface polymer formation kinetics for at least 2 hours when the pH level is kept constant in this time period.

### Example 8

Characterization by UV/Vis and Determination of pKₐH₁ and pKₐH₂ Values of Copper/Ligand Complexes

In this example, solutions of different copper/ligand complexes are analyzed by titration curves to determine the complex-specific pKₐH₁ and pKₐH₂ values.

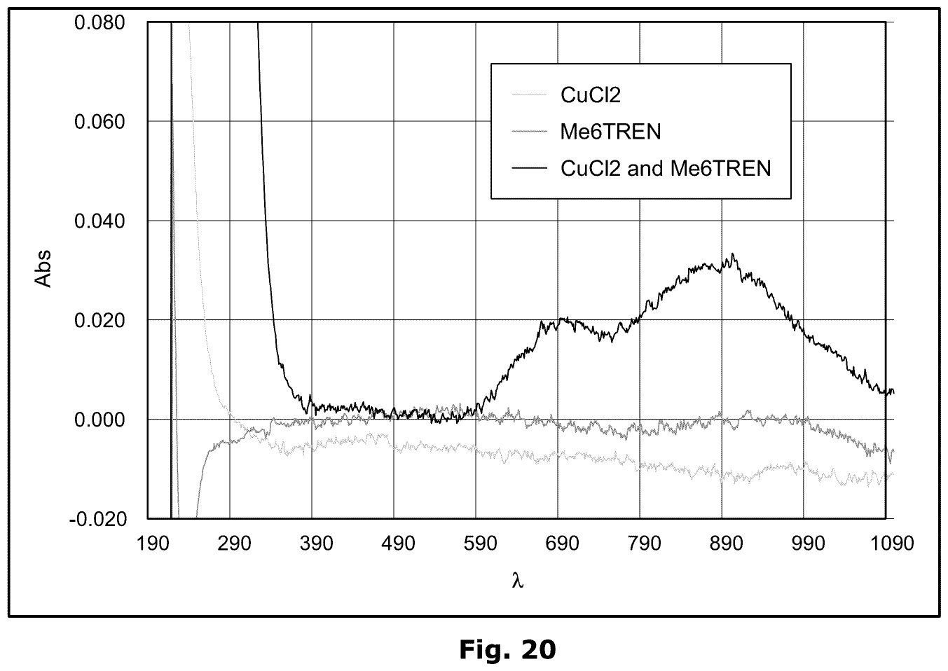

UV/Vis spectroscopic analysis (LLG-uniSPEC 2 Spectrophotometer) was performed for a catalyst solution prepared as described in Example 3, established to be of a native pH of 11.8. The hereby obtained UV/Vis spectrum was compared to UV/Vis spectra of a second solution containing CuCl₂·2H₂O (13.6 mg, ≥99.5% grade, from Sigma-Aldrich) in DI-water (16 mL) with no ligand, and a third solution containing 76 μL tris[2-(dimethylamino)ethyl]amine (Me₆TREN, ligand, commercially available, ≥98% grade from abcr or Alfa Aesar) and DI-water (15.924 mL) with no copper species. It is demonstrated in FIG. 20 that a species with a characteristic visible-light region absorbance profile exists only when both copper and Me₆TREN are present, and the absorbance profile is consistent with literature values for the Cu(II)/Me₆TREN complex. Similar spectroscopic analysis may be performed for other copper-ligand complexes as needed.

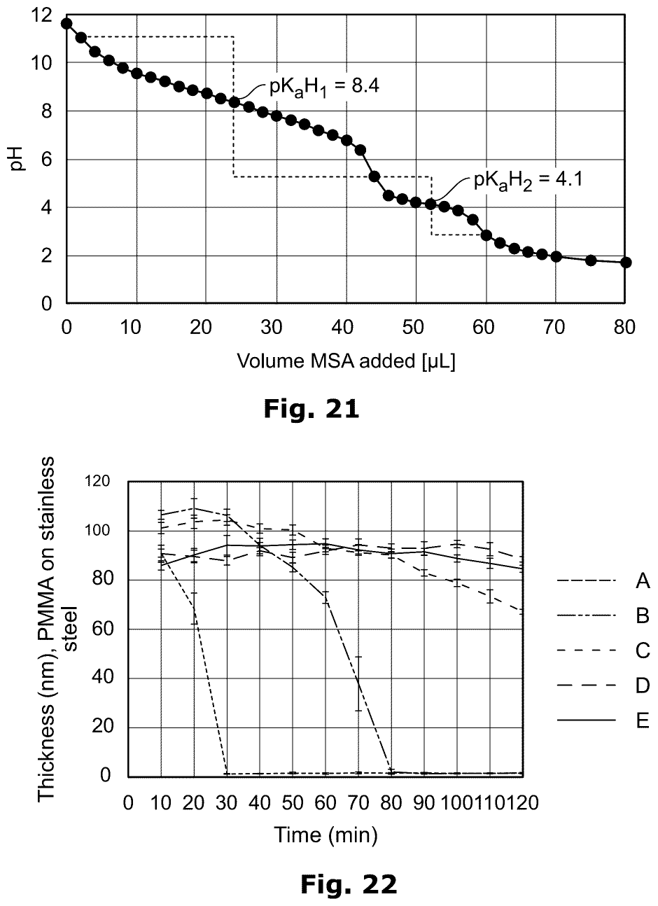

Establishment of pKₐH₁ and pKₐH₂ values for a specific catalyst/ligand complex may be performed through titration with an acid or base. As an example, 16 mL of catalyst solution (described in Example 3) was added to a 20 mL glass vial equipped with a pH meter and a magnetic stirring bar. Then, incremental addition of methanesulfonic acid (≥99% grade from Sigma-Aldrich) while stirring was carried out. By comparing the precise amounts of acid added to the resulting solution pH, pKₐH₁ and pKₐH₂ values were obtained from half equivalence points (FIG. 21). Similar methodology may be employed for determination of pKₐH₁ and pKₐH₂ values of different copper-ligand complexes. Specific pKₐH₁ and pKₐH₂ values for some copper/ligand complexes obtained in this way are disclosed in Table 7.

TABLE 7
Specific copper/ligand complexes of the pKₐH
investigations and the pKₐH values obtained herein.

| Solution | Catalyst/ligand complex | pKₐH₁ | pKₐH₂ |
|---|---|---|---|
| i | Cu/Me₆TREN | 8.4 | 4.1 |
| ii | Cu/PMDETA | 8.6 | 3.4 |
| iii | Cu/TREN | 9.4 | 3.5 |

The pKₐH₁ and pKₐH₂ thus obtained allow for defining the suitable pH ranges for surface polymer formation. For the specific complex copper/Me₆TREN (FIG. 21) it was found that pKₐH₁=8.4 (in agreement with literature, https://pubs.acs.org/doi/10.1021/acs.macromol.5b01454) and pKₐH₂=4.1. Therefore, at pH ≥8.4, high surface polymerization rate is expected; at 8.4>pH >4.1, controlled surface polymerization rate is expected; at pH≤4.1, ineffective surface polymerization rate is expected.

Corresponding analyses of catalyst systems containing ligands other than Me₆TREN may be performed analogously. As an example, for the specific complex Cu/PMDETA it was found that pKₐH₁=8.6 and pKₐH₂=3.4. Therefore, at pH ≥8.6, high surface polymerization rate is expected; at 8.6>pH >3.4, controlled surface polymerization rate is expected; at pH≤3.4, ineffective polymerization rate is expected. As another example, for the specific complex Cu/TREN it was found that pKₐH₁=9.4 and pKₐH₂=3.5. Therefore, at pH≥9.4, high polymerization rate is expected; at 9.4>pH >3.5, controlled polymerization rate is expected; at pH≤3.5 ineffective polymerization rate is expected.

### Example 9

### Formation of Surface Polymer (Polymer Brush) in a Continuous Manner at Different Concentrations of Oxygen Control Agent

In this example, the influence of the concentration of sodium ascorbate catalyst activator acting as oxygen control agent on the bath life of the reaction composition and the effect on the ability to form surface polymers in a continuous manner are shown. Different sodium ascorbate loadings (concentrations) were tested by changing the amount of sodium ascorbate dissolved in DI-water added (“Container B”, cf. Example 3).

Steel substrates and silicon wafer substrates were pre-cleaned as described in Example 1, and polymerization initiators were attached on the surface as described in Example 2. Reaction compositions A-F were prepared as described in Example 3 but varying the sodium ascorbate loading as defined in Tables 9 and 10 below. The substrate handling and number of substrates were as described in Example 4.

TABLE 8
Contents of Containers A and B prior to mixing (activation of catalyst).

| Container A | | | | | |
|---|---|---|---|---|---|
| | | | Monomer | Container B | |
| | DI- | | (methyl | Sodium | |
| Catalyst solution | water | Ethanol | methacrylate) | ascorbate | DI-water |
| 16 mL | 484 mL | 410 mL | 75 mL | See | See Table 9 |
| c(Cu) = 0.081 mM | | | (0.71M) | Table 9 | |
| c(Me₆TREN) = 0.29 mM | | | | | |
| Ratio, | | | | | |
| c(Me₆TREN):c(Cu) = 3.5:1 | | | | | |

TABLE 9
Specific contents of Container B and bath life for
exemplified reaction compositions A-F.

| Reaction | | | |
|---|---|---|---|
| composition | Sodium ascorbate | DI-water | Bath life |
| A | 200 mg | 15 mL | 20 min |
| | c(NaAsc) = 1.01 mM | | |
| B | 400 mg | 15 mL | 60 min |
| | c(NaAsc) = 2.02 mM | | |
| C | 1.00 g | 15 mL | 100 min |
| | c(NaAsc) = 5.05 mM | | |
| D | 2.00 g | 15 mL | ≥120 min |
| | c(NaAsc) = 10.1 mM | | |
| E | 4.00 g | 15 mL | ≥120 min |
| | c(NaAsc) = 20.2 mM | | |
| F | 20.0 g | 75 mL | 70 min |
| | c(NaAsc) = 100 mM | | |

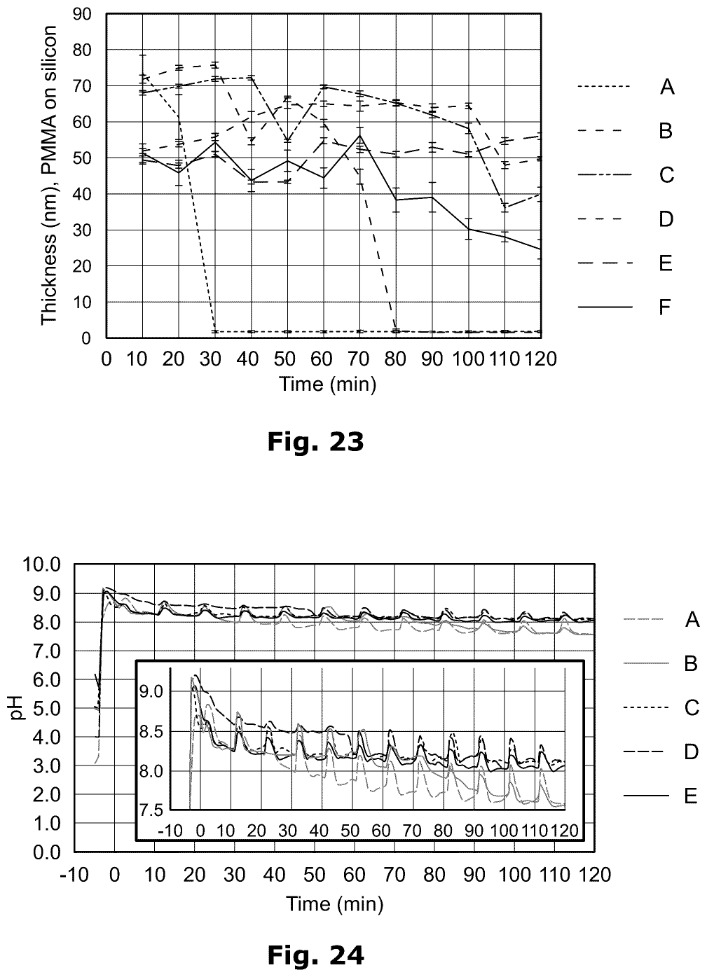

For each reaction composition A to F, assessment of the surface polymer forming ability over time was performed as described in Example 4 (multiple surface polymer-forming events). FIG. 22 and FIG. 23 show the yielded dry surface polymer thickness as a function of time after activation of the reaction compositions, and FIG. 24 shows the pH of reaction composition measured over time. From these data, it was concluded that the bath lives obtained were 20 minutes (reaction composition A), 60 minutes (reaction composition B), 100 minutes (reaction composition C), ≥120 minutes (reaction composition D-E), or 70 minutes (reaction composition F). From these results, a lower boundary for the concentration of sodium ascorbate is suggested to be at least 1.01 mM to ensure a bath life of at least 20 minutes (reaction composition A) at least for the catalyst/ligand complex Cu/Me₆TREN. The results also suggest that an upper concentration of sodium ascorbate may be dependent on the solubility of the oxygen control agent/catalyst activator in the chosen reaction composition. In fact, a high concentration of sodium ascorbate may help keeping pH >pKₐH₁ in the reaction composition. A connection is seen between the bath life length and the pH value of the reaction composition; for compositions C, D, and E, with bath lives ≥120 min, very similar pH values of 8.2-8.5 are recorded over time, all above pKₐH₁ of the Cu/Me₆TREN complex. In comparison, for composition B, with a bath life of 60 minutes, a drop in pH value over time is seen, starting at 60 minutes. Lastly, composition A, with a bath life of 20 minutes, a drop in pH value over time is seen, starting at 20 minutes. In both cases pH is dropping below pKₐH₁ of the Cu/Me₆TREN complex.

Furthermore, it is demonstrated that one component, in this case sodium ascorbate, may function both as catalyst activator and oxygen control agent, with no negative effect on the activation of the catalyst, or on the control of the molecular oxygen concentration. By controlling the concentration of sodium ascorbate in the reaction composition initially, the timespan for extended use of the reaction composition and the continued formation of surface polymers with stable kinetics may be controlled.

### Example 10

### Formation of Surface Polymer (Polymer Brush) Using a Variety of Ligands

In this example, it is demonstrated that using an oxygen control agent is beneficial in different ligand systems. Other ligands (Table 11) were tested by replacing the Me₆TREN-based catalyst solution (“Container A”, cf. Example 3) with a stock solution consisting of copper(II) chloride dihydrate and a ligand dissolved in DI-water (see Table 10 below) keeping constant both the concentrations and molar ratio of copper and ligand, respectively.

Si substrates were pre-cleaned as described in Example 1, and polymerization initiators were attached on the surface as described in Example 2. Reaction compositions 1-3 were prepared as described in Example 3, but using CuCl₂ as copper source and ligand defined in Tables 11 and 12 below. In “container B” (cf Example 3), a mixture of 4.00 g (20.2 mM) sodium ascorbate dissolved in 15 mL DI-water was used for all ligands.

TABLE 10
Components (c, concentration) present in
Container A prior to mixing with Container B.
Container A

| | | | | Monomer |
|---|---|---|---|---|
| | | | | (methyl |
| | | | | metha- |
| CuCl₂•H₂O | Ligand | DI-water | Ethanol | crylate) |
| 13.6 mg | See Table 11 | 500 mL | 410 mL | 75.0 mL |
| c(Cu) = | c(ligand) = 0.29 mM | | | (0.71M) |
| 0.08 mM | Ratio, ligand:Cu = 3.5:1 | | | |

TABLE 11
Specific contents of Container A and bath life for
exemplified reaction compositions 1-3.

| Reaction composition | Ligand | Bath life |
|---|---|---|
| 1 | Me₆TREN | >120 min |
| | Volume = 77.5 μL | |
| 2 | PMDETA | >120 min |
| | Volume = 60.5 μL | |
| 3 | TPMA | >120 min |
| | Mass = 84.2 mg | |

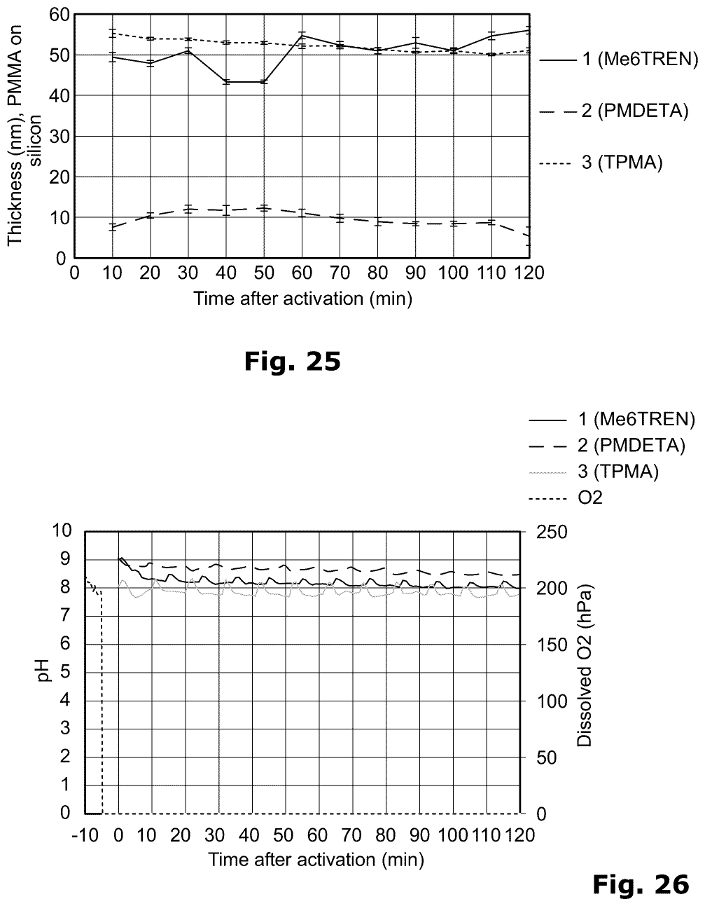

For each reaction compositions 1-3, assessment of the polymer brush forming ability over time was performed as described in Example 4. FIG. 25 shows the yielded dry surface polymer thickness measured by ellipsometry (J. A. Woollam M-2000 Ellipsometer) as a function of time after activation of the reaction compositions. From these data, it was concluded that the bath lives obtained were at least 120 minutes (experiment stopped at 120 minutes) using either Me₆TREN (reaction composition 1), PMDETA (reaction composition 2), or TPMA (reaction composition 3) as ligand. Hence, all three ligand systems can successfully be used as ligands in the reaction composition and the methods disclosed herein with the simultaneous use of sodium ascorbate as combined catalyst activator and oxygen control agent. Furthermore, pH values and the partial pressure of dissolved O₂ were measured continuously in the reaction composition during these investigations, shown in FIG. 26, showing in all cases stable pH values over time and a partial pressure of dissolved O₂˜0 hPa, after addition of the activation agent. For Cu/TPMA as catalyst/ligand complex, pH is above pKₐH₁, and for Cu/Me₆TREN and Cu/PMDETA as catalyst/ligand complexes, pH in the solution is similar to pKₐH₁. This highlights that at pH ≥pKₐH₁, the reaction composition can be used for extended formation (a prolonged period of time) of surface polymers on multiple substrates with stable kinetics.

### Example 11

Demonstrating Surface Polymer (Polymer Brush) Forming Ability (Lifetime) on a Series of Substrates Using a Reaction Composition as Disclosed Herein in Combination with a Buffer

This example demonstrates the capability to modulate a buffered reaction composition (including monomer, solvent system, and ligand based on Cu) according to the herein described specifications to obtain a system with a stable surface polymer forming ability over an extended timeframe which produces a specific surface polymer on a substrate.

Silicon wafer substrates (same grade as described in Example 1) were pre-cleaned as described in Example 1, and polymerization initiators were attached on/bonded to the surface as described in Example 2. Reaction compositions were prepared as described in Example 3, but with (1) replacement of 16 mL catalyst solution with CuCl₂·2H₂O (13.6 mg), PMDETA (ligand, 60 μL), and DI-water (16 mL), (2) replacement of 484 mL DI-water with glycine (buffer, 2807 mg, NaOH (pH controlling agent, 550 mg), and DI-water (cosolvent, 374 mL), (3) replacement of 410 mL ethanol with iso-propanol (cosolvent, 537 mL), and (4) replacement of 75 ml methyl methacrylate with tert-butyl methacrylate (monomer, 75 ml).

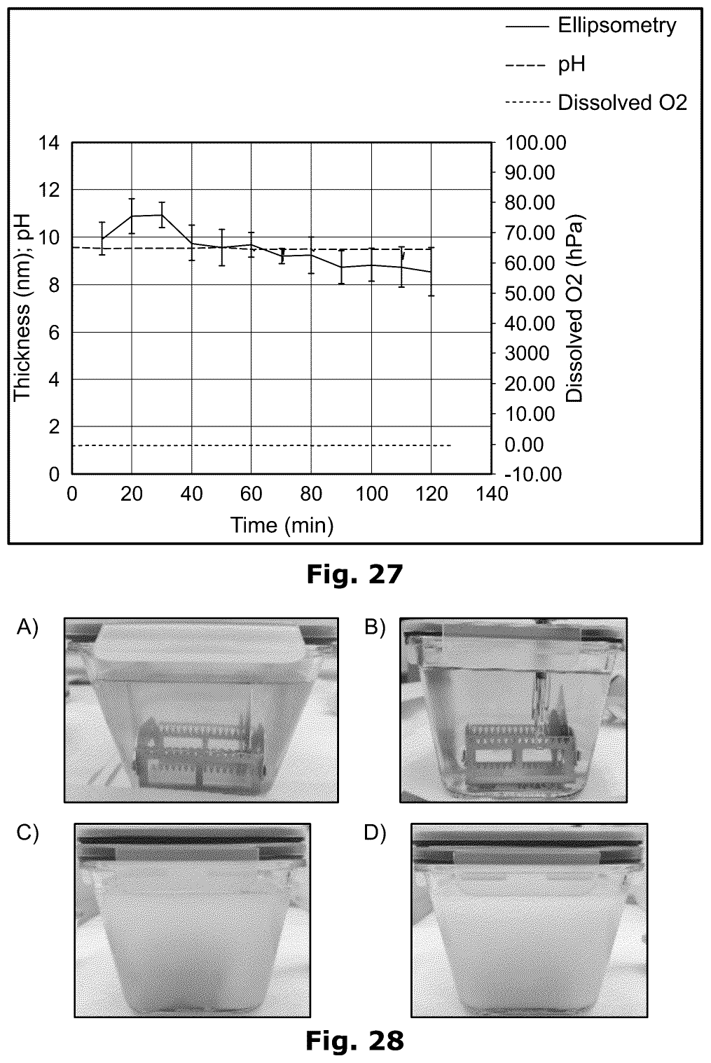

Assessment of the surface polymer (polymer brush) forming ability over time was also performed as described in Example 4 with measurements of pH of the reaction composition (Metrohm 913 pH meter) and of dissolved oxygen in the reaction composition (Pyroscience FireSting-GO2). The obtained polymer brush thicknesses, the pH, and O₂ partial pressure as functions of time are shown in FIG. 27.

The concentration of dissolved oxygen and the pH of the reaction composition is demonstrated to be consistent throughout the 120 minutes wherein measurements were obtained. The thickness of surface polymer on the substrates was on each substrate 9.5 nm+/−15% throughout the 120 minutes tested. From these data, it was concluded that the bath life obtained was ≥120 minutes. Thus, when compared to e.g. the system described in Example 7, reaction composition a, it is here demonstrated that buffered reaction compositions which display stable kinetics over a prolonged time period may be obtained with variations in both the solvent system, ligand on Cu, and employed monomer.

### Example 12

### pH Impact on Surface Polymer (Polymer Brush) Formation Using a pH Control Agent

In this example, the dependency of the surface polymerization on the pH of the reaction composition is demonstrated by employing an acid additive as pH control agent and assessing the resulting surface polymer formation and bulk polymer formation.

Silicon wafer substrates were pre-cleaned as described in Example 1, and polymerization initiators were attached on the surface as described in Example 2. Reaction compositions I-VI were prepared as described in Example 3 (Cu/Me₆TREN as ligand), but with the addition of varying amounts (Table 12) of methanesulfonic acid (MSA, commercially available, ≥99% grade from Sigma-Aldrich); I: 0 mL (reference substrate), II: 50 μL, III: 110 μL, IV: 225 μL, V: 650 μL, and VI: 1300 μL. In this way, reaction compositions with different pH values were obtained, allowing for investigating the relationship between their surface polymer forming abilities and their pH level. For each reaction composition, the kinetics of the surface polymer formation was assessed by immersing 6 Si wafers with initiators attached in the reaction composition at the same time—at minute 0. Minute 0 is defined as 5 minutes after addition of (a solution of) catalyst activator (NaAsc). A substrate was removed from the reaction composition after 2, 5, 7.5, 10, 20, and 40 minutes and subsequently cleaned by sonication in DI-water for 5 minutes, followed by sonication in acetone for 5 minutes. The substrates were allowed to dry in ambient air before the dry film thicknesses of the formed (collapsed) surface polymers were analyzed using ellipsometry (Table 12).

TABLE 12
Use of pH control agent (methanesulfonic acid) in the reaction composition.

| | Container A | | | | | | | |
|---|---|---|---|---|---|---|---|---|
| | | | | Monomer | Methane | | Container B | |
| Reaction | Catalyst | DI- | | (methyl | sulfonic | | Sodium | DI- |
| composition | solution | water | Ethanol | methacrylate) | acid | | ascorbate | water |
| A | 16 mL | 484 mL | 410 mL | 75 mL | 0 | μL | 4 g | 15 mL |
| B | 16 mL | 484 mL | 410 mL | 75 mL | 50 | μL | 4 g | 15 mL |
| C | 16 mL | 484 mL | 410 mL | 75 mL | 110 | μL | 4 g | 15 mL |
| D | 16 mL | 484 mL | 410 mL | 75 mL | 225 | μL | 4 g | 15 mL |
| E | 16 mL | 484 mL | 410 mL | 75 mL | 650 | μL | 4 g | 15 mL |
| F | 16 mL | 484 mL | 410 mL | 75 mL | 1300 | μL | 4 g | 15 mL |

Immediately following the application of each reaction composition for surface polymer formation as described, the reaction composition was photographed to document an increased degree of bulk polymer formation over time at lower pH values (FIG. 28). As reference, the reaction composition A (FIG. 28 A)), with no added MSA, maintained transparency throughout the 40 minutes during which surface polymer formation was occurring, thereby witnessing a low degree of bulk polymerization. The reaction composition B (FIG. 28 B)) likewise maintained a degree of transparency. However, reaction compositions C (FIG. 28 C)) through F (FIG. 28 D) being representative of compositions D, E and F) were fully opaque, or highly turbid, after the 40 minutes during which surface polymer formation was occurring. It was concluded that the rate of bulk polymer formation is dependent on the pH value of the reaction composition. This finding supports the proposal that at lower pH, the concentration of H₂O₂ increases, the effect of which is an increased rate of bulk polymer formation.

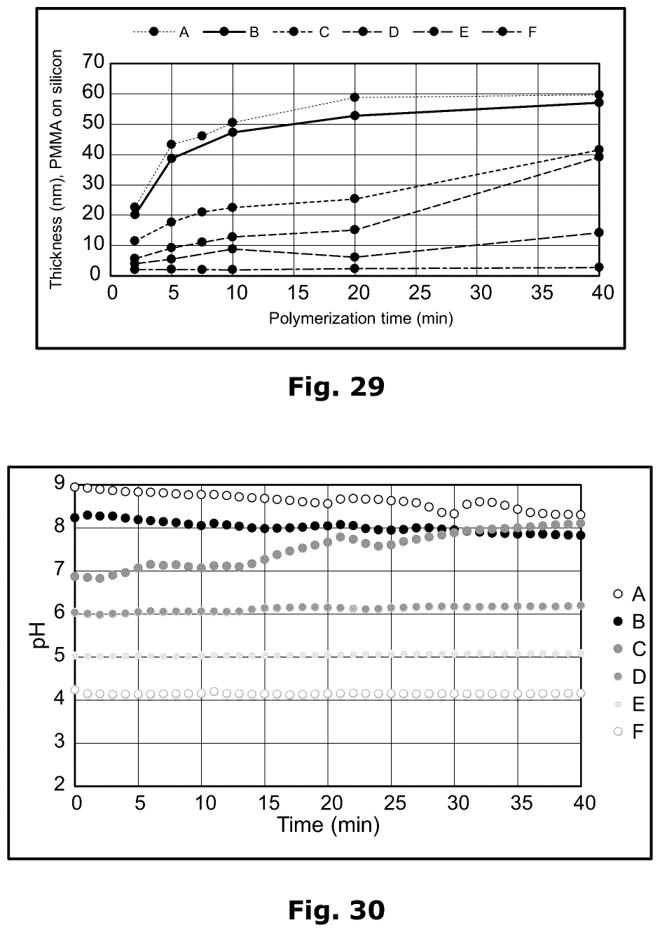

FIG. 29 shows the polymer film thickness as a function of surface polymer formation time for reaction compositions A-F. The corresponding pH values can be seen in FIG. 30. From these data, it is seen that the surface polymer-forming ability of a reaction composition is highly dependent on the pH value.

Polymerization at pH≥8 (reaction compositions A and B) led to a high degree of surface polymer formation, with high surface polymer formation rates.

Comparatively, polymerizations at pH 7, 6, or 5 (reaction compositions C, D and E, respectively) led to gradually lower degrees of surface polymer formation.

At pH 4 (reaction composition F), an insignificant amount of surface polymer was formed. Hence, the Cu/Me₆TREN complex was not able to catalyze the surface polymer formation at pH<4, corresponding to pH<pKₐH₂ of the Cu/Me₆TREN complex.

These findings demonstrate that Cu/Me₆TREN complex is less efficient (but still maintaining activity) at pH<pKₐH₁ and ineffective at pH<pKₐH₂. Furthermore, these studies witness the capability of modulating the rate of surface polymer formation through dictating and maintaining a specific pH of the surface polymer-forming reaction composition; a fast rate of polymerization may be accommodated by maintaining a constant pH>pKₐH₁, while a slow rate of polymerization may be accommodated by maintaining a constant pH between pKₐH₁ and pKₐH₂. Both scenarios may be highly beneficial depending on the specific application. A limitation to the method is the absence of surface polymer formation at pH<pKₐH₂; in case a surface polymerization is needed to function at low pH, a catalyst/ligand complex with a comparatively lower pKₐH₂ should be employed.

### Example 13

### Procedure for the Assessment of Poly(Styrene) Surface Polymer (Polymer Brush) Forming Ability

This example illustrates a procedure for assessment of the surface polymer poly(styrene) polymer brush forming ability of the reaction composition over time. This procedure serves as a reference in a subsequent example.

Silicon wafer substrates (same grade as described in Example 1) were pre-cleaned as described in Example 1, and polymerization initiators were attached to/bonded to the surface as described in Example 2.

The pH control agent used in the polymer brush forming process was made by dissolving 6.020 g glycine and 2.050 g sodium hydroxide (NaOH, commercially available from Th. Geyer GmbH & Co. KG) in 1 L DI water (measured pH=10.06).

The polymer brush forming solution was prepared as follows: To a container (container A) was added: 30 mL catalyst solution (described in Example 3), 450 mL glycine buffer, 10 mL DI water, 480 mL, and 20 mL styrene monomer (commercially available, grade ≥99.9% from Merck Life Science ApS). In a separate container (container B), 4.00 g sodium ascorbate catalyst activator was dissolved in 15 mL DI-water. The content of container B was mixed into container A. The silicon wafer substrates with polymerization initiator in a 1200 mL reaction container. After 5 minutes, the liquid was ready to use for surface polymerization and poured into the 1200 mL reaction container.

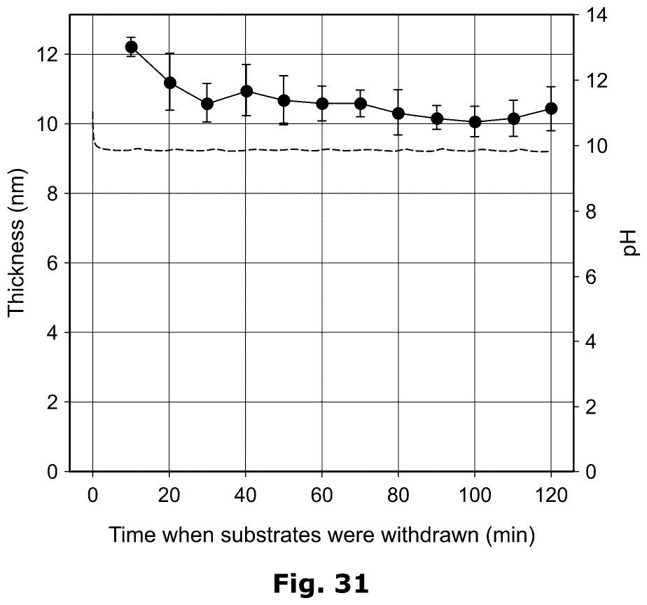

After surface polymer formation, the substrates were cleaned collectively by sonication in DI-water (grade as Example 1) for 5 minutes, followed by sonication in acetone (with specification as described in Example 1) for 5 minutes, followed by sonication in dichloromethane (DCM, 99.9% grade from Chemsolute) for 5 minutes. The substrates were allowed to dry in ambient air. The inner layer thicknesses were analyzed by ellipsometry as described in Example 4 (formation of surface polymer on multiple substrate surfaces in a sequential manner). The pH of the reaction composition was continuously measured with the pH meter. The obtained polymer brush thicknesses, and the pH concentration as functions of time are shown in FIG. 31.

### Example 14

### Assessment of Surface Block Copolymer (Block Copolymer Brush) Forming Ability on a Set of Substrates Using the Method Disclosed Herein.

This example illustrates a procedure for assessment of the block copolymer brush forming ability. Silicon wafer substrates (same grade as described in Example 1) were pre-cleaned as described in Example 1, and polymerization initiators were attached on/bonded to the surface as described in Example 2. The reaction composition for forming the inner layer consisting of polymethyl methacrylate (MMA) was prepared as described in Example 7, using reaction composition c as described in Table 13. 58.601 g sodium chloride (NaCl, commercially available, 99.0% grade from Chemsolute) was added to ensure the block copolymer brush forming ability. The reaction composition for forming the outer layer (block layer) consisting of polystyrene (PST) was prepared as described in Example 13.

The pH control agent used in the block copolymer brush forming process was made by dissolving 6.020 g glycine and 2.050 g sodium hydroxide (NaOH) in 1 L DI water (measured pH=10.06).

The inner layer forming reaction composition was poured into the reaction chamber containing 14 silicon wafer substrates with attached polymerization initiators placed in a rack. The substrates were left to react (form surface polymers) for 20 minutes. After surface polymerization, the substrates were cleaned collectively by sonication in DI-water (grade as Example 1) for 5 minutes, followed by sonication in acetone (with specification as described in Example 1) for 5 minutes, followed by sonication DCM for 5 minutes. The substrates were allowed to dry in ambient air. The inner layer thicknesses were analyzed by ellipsometry using the instrument described in Example 4.

The block layer forming reaction composition was poured into the reaction chamber containing 14 silicon wafer substrates with PMMA polymer brush placed in a rack. The substrates were left to react for 30 minutes. After surface polymer formation, the substrates were cleaned and analyzed as described above. Results are reported in Table 13.

TABLE 13

| Substrate | Inner layer thickness | Block layer thickness |
|---|---|---|
| no. | (nm) | (nm) |
| 1 | 77 ± 1 | 99 ± 5 |
| 2 | 74 ± 1 | 100 ± 3 |
| 3 | 74 ± 1 | 99 ± 2 |
| 4 | 73 ± 2 | 98 ± 4 |
| 5 | 73 ± 1 | 98 ± 3 |
| 6 | 75 ± 1 | 97 ± 3 |
| 7 | 80 ± 1 | 112 ± 3 |
| 8 | 74 ± 1 | 91 ± 2 |
| 9 | 80 ± 1 | 104 ± 5 |
| 10 | 80 ± 1 | 100 ± 6 |
| 11 | 79 ± 1 | 97 ± 6 |
| 12 | 78 ± 1 | 101 ± 5 |
| 13 | 76 ± 1 | 108 ± 4 |
| 14 | 78 ± 2 | 106 ± 7 |

The degrafting reaction composition comprised of 1.408 g tetrabutylammonium fluoride (commercially available, 98.2% grade from Sigma-Aldrich) dissolved in 100 mL DCM. The degrafting was initiated by pouring the reaction composition into a reaction chamber (20×30×6 cm) containing 14 substrates with PMMA-b-PST polymer brush placed horizontally, coated side up, on the bottom of the reaction chamber. The reaction chamber was sealed with a lid and left on a laboratory stirring table (50 rpm) for 22 hours.

After degrafting, the degrafting solution was collected and each silicon wafer was rinsed in DCM. The DCM used for rinsing was collected along with the degrafting reaction in a flask. The combined degrafting composition and DCM was reduced by flushing the headspace with N₂ gas yielding a yellow oil.

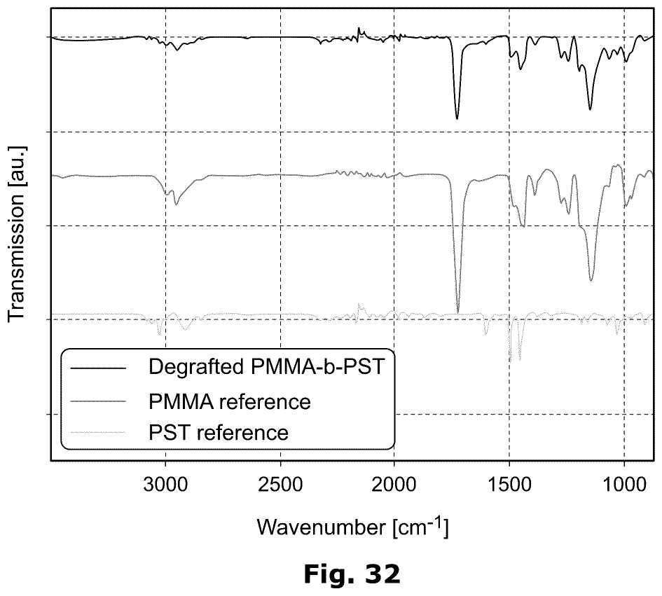

The yellow oil was dropped into 40 mL cold methanol (stored at −18° C., commercially available, 99.85% grade from Chemsolute) in a 50 mL centrifugation tube and subjected to centrifugation (3900 rpm, 5 min). After centrifugation the centrifugation tube was decanted, and the pellet recovered. The pellet was dissolved in DCM and the liquid was dropped into 40 mL cold methanol in a 50 mL centrifugation tube and subjected to centrifugation (3900 rpm, 5 min). The recovered pellet was measured using IR. A comparison of degrafted PMMA-b-PST (FIG. 32, top) to PMMA (ALTUGLAS™ VM, commercially available from Resinex) and PST (Mw ˜192,000 Da, commercially available from Sigma Aldrich, product number: 430102) reference spectra (FIG. 32, middle and bottom, respectively) confirmed that degrafted PMMA-b-PST featured traits from both polymer types: from the IR analysis the presence of the PMMA structure is verified by the 1727, 1485, 1437, 1390, 1275, 1243, 1191, and 1144 cm⁻¹ stretches and the presence of the PST structure is verified by the 1604, 1497 and 1453 cm⁻¹ stretches confirming the block structure.

### Example 15

### Demonstrating Oxygen Control and Surface Polymer Formation Using Sodium Dithionite as Oxygen Control Agent to Form Surface Polymers on a Plurality of Substrates in a Continuous (Sequential) Manner (Method as Disclosed Herein)

This example confirms the ability to use other oxygen control agents to accommodate the surface polymer formation as described herein. Sodium dithionite is a reagent which may rapidly scavenge oxygen in an aqueous solution. This reagent is consumed at a higher rate than sodium ascorbate due to its inherent reactivity not only toward oxygen, but also water, meaning that a stable, low concentration of dissolved oxygen in aqueous solutions over a prolonged time demands multiple additions of sodium dithionite. Herein, it is demonstrated that continuous additions of sodium dithionite allow for obtaining a reaction composition which displays an extended bath life, accommodating several subsequent polymerizations of individual substrates.

Silicon wafer substrates (same grade as described in Example 1) were pre-cleaned as described in Example 1. These were functionalized by vapor deposition of 3-aminopropyltrimethoxysilane (APTMS) by placing them in a desiccator containing 6×100 μL of APTMS in small glass vials. The chamber was evacuated using a vacuum pump for 5 minutes, and the desiccator chamber was then closed and left at room temperature. After 1 h, the pressure of the desiccator was equalized, and the substrates were placed in an oven set to 100° C. for 1 h. The APTMS-coated substrates were further functionalized to carry an initiator for surface polymerization by submersion into a glass vessel containing a-bromoisobutyryl bromide (BIBB) (174 mL, 98% grade from Sigma-Aldrich), triethylamine (20 mL, ≥98% grade from Sigma-Aldrich) and dichloromethane (2610 mL, 99.9% grade from Chemsolute). The reaction medium was placed on a shaking table, set to 50 RPM, for 1 h. The substrates were then flushed with dichloromethane, sonicated in dichloromethane for 5 min, and sonicated in acetone for 10 minutes. These APTMS-BIBB coated substrates were dried under a stream of argon before proceeding with the surface polymer forming modification as described below.

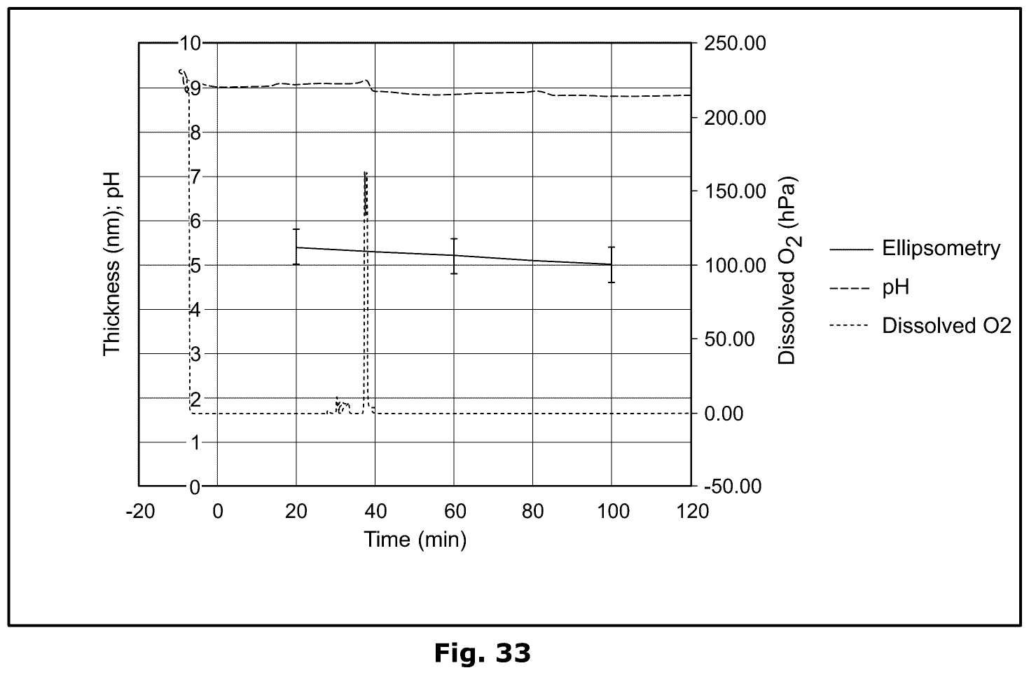

To a glass container (container A) equipped with a lid, a pH meter (Metrohm 913 pH meter) and an O₂ sensor (Pyroscience FireSting-GO2) was added: 16 mL catalyst solution (prepared as described in Example 3), a solvent mixture consisting of a 0.1 M solution of glycine (99.5% grade, from Chemsolute, 7.5 g/l) in DI-water (500 mL) and EtOH (96% grade from Kiiltoclean, 8 mL, 96%), and 75 mL methyl methacrylate monomer (99% grade containing ≤30 ppm MEHQ, from Sigma-Aldrich). In each of 3 separate glass containers (containers B1, B2, and B3), sodium dithionite (≥85% grade from Merck, 17.5 g) in DI-water (10 mL) were mixed. The contents of Container B1 was added to Container A. At this time point (defined as minute 0), the first substrate was added to container A. At minute 20, the first substrate was recovered from the reaction composition in container A. At minute 40, the contents of Container B2 and the second substrate were added to Container A. The oxygen sensor was quickly extracted from the reaction composition and then resubmerged to verify O₂ measurements; a spike in the oxygen measurements was observed. At minute 60, the second substrate was recovered from the reaction composition in container A. At minute 80, the contents of Container B3 and the third substrate were added to Container A. At minute 100, the third substrate was recovered from the reaction composition in container A. The substrates were cleaned and analyzed as described in Example 4. Ellipsometric analysis data, O₂ measurements, and pH measurements are shown in FIG. 33). The ellipsometric analysis data is further given in Table 14.

TABLE 14
Ellipsometric analysis of Si wafers subjected
to the procedure as described.

| Time after activation (min) | Thickness on Si (nm) |
|---|---|
| 20 | 5.4 ± 0.4 |
| 60 | 5.2 ± 0.4 |
| 100 | 5.0 ± 0.4 |

These results show that the bath life of the reaction composition as described here was ≥100 minutes. Further, this result shows that the method as described herein may facilitate surface polymer formation using different oxygen control agents which the specifications as described herein.

### LIST OF REFERENCE NUMERALS

100 System
102 Substrate
103 Substrate displacement device
104 Reaction composition container
105 Reaction composition
106 Polymerization initiator chemistry container
107 Polymerization initiator chemistry
109 Annealing oven
111 Oven gas
114 Cleaning agent container
116 Cleaning agent
118 Roll-to-roll processor
120 Roller
121 Sending roll
122 Receiving roll
123 Flexible elongated substrate
202 Dispenser
204 Dispenser
206 pH control agent
208 O₂ control agent
210 Control unit
216 pH sensor
218 O₂ sensor
211 Recirculation circuit
302 Process flow step for control of pH control agent dispenser
304 Process flow step for control of pH control agent dispenser
306 Process flow step for control of pH control agent dispenser
308 Process flow step for control of pH control agent dispenser
402 Process flow step for control of molecular oxygen control agent dispenser
404 Process flow step for control of molecular oxygen control agent dispenser
406 Process flow step for control of molecular oxygen control agent dispenser
408 Process flow step for control of molecular oxygen control agent dispenser
501 Clean step in an example surface polymer formation flow
503 Anneal step in an example surface polymer formation flow
505 Clean step in an example surface polymer formation flow
507 Anneal step in an example surface polymer formation flow
509 Formation step in an example surface polymer formation flow
511 Clean step in an example surface polymer formation flow
513 Anneal step in an example surface polymer formation flow

What is claimed is:

1. A reaction composition for surface polymer formation comprising:
at least one monomer;
at least one ligand and at least one catalyst, wherein the at least one ligand and the at least one catalyst form a complex;
at least one catalyst activator;
at least one solvent; and
at least one polymerization control agent;
wherein the at least one polymerization control agent comprises at least one pH control agent for controlling pH of the reaction composition during surface polymer formation and wherein the at least one pH control agent maintains the pH of the reaction composition above a pKₐH of the complex formed between the at least one catalyst and the at least one ligand.

2. A reaction composition according to claim 1, wherein the at least one pH control agent maintains the pH of the reaction composition above the pKₐH₁ of the complex formed between the at least one catalyst and the at least one ligand.

3. A reaction composition according to claim 1, wherein the at least one pH control agent maintains the pH of the reaction composition above the pKₐH₂ of the complex formed between the at least one catalyst and the at least one ligand.

4. A reaction composition according to claim 1, wherein the at least one pH control agent maintains the pH of the reaction composition between pKₐH₁ and pKₐH₂ of the complex formed between the at least one catalyst and the at least one ligand.

5. A reaction composition according to claim 1, wherein the at least one pH control agent is a buffer.

6. A reaction composition according to claim 1, wherein the at least one pH control agent is an acid or a base.

7. A reaction composition according to claim 1, wherein the polymerization control agent further comprises at least one oxygen control agent for controlling the molecular oxygen concentration in the reaction composition.

8. A reaction composition according to claim 7, wherein the at least one oxygen control agent maintains the molecular oxygen concentration in the reaction composition below a partial pressure of 25 hPa.

9. A reaction composition according to claim 7, wherein the at least one oxygen control agent is an oxygen scavenger.

10. A reaction composition according to claim 1, wherein the at least one polymerization control agent comprises the pH control agent for controlling the pH of the reaction composition during surface polymer formation and an oxygen control agent for controlling the molecular oxygen concentration in the reaction composition during surface polymer formation.

11. A method for forming surface polymers comprising:
bringing at least a portion of a polymerization initiator-modified substrate into contact with a reaction composition comprising:
at least one monomer;
at least one ligand and at least one catalyst, wherein the at least one ligand and the at least one catalyst form a complex;
at least one catalyst activator; and
at least one solvent;
controlling the surface polymerization by means of pH of the reaction composition or by means of pH of the reaction composition and molecular oxygen concentration of the reaction composition; and
adding at least one polymerization control agent to adjust the pH of the reaction composition above a pKₐH of the complex formed between the at least one catalyst and the at least one ligand.

12. A method according to claim 11, wherein the at least one polymerization control agent is added at least once during, or prior to, the surface polymer formation.

13. A method according to claim 11, wherein the at least one polymerization control agent is functioning as pH control agent and oxygen control agent.

14. A method according to claim 11, further comprising:
bringing at least a portion of a first polymerization initiator-modified substrate into contact with the reaction composition in the reaction composition container thereby forming surface polymers on said first substrate;
withdrawing said first substrate from the reaction composition in the reaction composition container;
subsequent to the withdrawing said first substrate, bringing at least a portion of a second polymerization initiator-modified substrate into contact with the reaction composition in the reaction composition container, thereby forming surface polymers on said second substrate; and
withdrawing said second substrate from the reaction composition in the reaction composition container.

15. A method according to claim 14, wherein the reaction composition is modified during the surface polymer formation by addition of further components of the reaction composition, and/or removal of bulk polymer byproducts.

16. A method according to claim 15, wherein pH of the reaction composition and/or molecular oxygen concentration of the reaction composition is controlled by measuring pH and/or molecular oxygen concentration during the surface polymer formation in combination with supplying at least one polymerization control agent.

17. A method according to claim 14, wherein a plurality of substrates is subjected to surface polymer formation in the reaction composition container in a consecutive manner.

18. A system for forming surface polymers on a substrate, the system comprising:
a reaction composition container containing a reaction composition, said reaction composition comprising:
at least one monomer;
at least one ligand and at least one catalyst, wherein the at least one ligand and the at least one catalyst form a complex;
at least one catalyst activator;
at least one solvent; and
at least one polymerization control agent for controlling the pH of the reaction composition during surface polymer formation and wherein the at least one pH control agent maintains the pH of the reaction composition above a pKₐH of the complex formed between the at least one catalyst and the at least one ligand; and
a substrate displacement device for bringing at least a portion of a polymerization initiator-modified substrate into contact with the reaction composition in the reaction composition container for a controlled time;
wherein the controlled time is sufficient for surface polymers to be formed on the portion of the polymerization initiator-modified substrate.

19. A system of claim 18, wherein the substrate displacement device comprises any one of:
a conveyor system;
a programmable mechanical arm; or
a roll-to-roll mechanism.

20. A system of claim 18, further comprising:
one or more sensors, each sensor configured to measure a different value of a characteristic of the reaction composition;
one or more dispensers configured to dispense one or more polymerization control agents and/or one or more components of the reaction composition into the reaction composition; and
a control unit operatively connected to the one or more sensors;
wherein the control unit is configured to output a control signal to the dispenser for dispensing the one or more polymerization control agents and/or the one or more components of the reaction composition into the reaction composition.

21. A system of claim 20, wherein the control unit is configured to output the control signal periodically to the dispenser, causing the dispenser to periodically dispense the polymerization control agent and/or the one or more components of the reaction composition into the reaction composition.

22. A system of claim 20, wherein the control unit is configured to output the control signal in dependence on receipt of a sensor signal indicative of a change in a value of a characteristic of the reaction composition or in dependence on receipt of a sensor signal indicative of the measured value of the characteristic or the reaction composition not complying with a predetermined threshold value of the characteristic of the reaction composition.

23. A system of claim 22, wherein the predetermined threshold value is a pH value and/or molecular oxygen concentration.

24. A system of claim 23, wherein a pH control agent and/or an oxygen control agent is dispensed into the reaction composition.

25. A system of claim 20, wherein the one or more components of the reaction composition comprises any one or more of: at least one monomer, at least one ligand, at least one catalyst, at least one catalyst activator, and at least one solvent.

26. A system of claim 18, further comprising a polymerization initiator container containing a polymerization initiator agent, wherein the substrate displacement device is configured to bring the portion of the substrate for attachment of polymerization initiators into contact with the polymerization initiator agent to form polymerization initiators at the substrate surface, prior to bringing the portion of the polymerization initiator-modified substrate into contact with the reaction composition.

27. A system of claim 18, further comprising a cleaning container, the cleaning container containing a cleaning agent, wherein the substrate displacement device is configured to bring the portion of the polymerization initiator-modified substrate into contact with the cleaning agent prior to, or subsequent to, bringing the portion of the polymerization initiator-modified substrate into contact with the reaction composition; or
the substrate displacement device is configured to bring the portion of substrate into contact with the cleaning agent prior to, or subsequent to, bringing the portion of the substrate into contact with the polymerization initiator.

28. A system of claim 18, further comprising an annealing container, the annealing container containing an annealing agent, wherein the substrate displacement device is configured to bring the portion of the substrate into contact with the annealing agent prior to, or subsequent to, bringing the portion of the substrate into contact with the polymerization initiator; or prior to, or subsequent to bringing the portion of the substrate into contact with the reaction composition.
